(19) United States
(12) Patent Application Publication
(10) Pub. No.: US 2011/0016317 A1
(43) Pub. Date: Jan. 20, 2011

(54) Key storage device, biometric authentication device, biometric authentication system, key management method, biometric authentication method, and program

(75) Inventor: Hiroshi Abe, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/803,182

(22) Filed: Jun. 21, 2010

(30) Foreign Application Priority Data
Jul. 15, 2009 (JP) P2009-167041

(51) Int. Cl. H04L 9/32; H04L 9/00; G06F 21/00

(52) U.S. Cl. 713/169; 713/186; 380/277

(57) ABSTRACT

Provided is a key storage device including a receiving unit for receiving package data that includes a template key for decrypting an encrypted template and an authentication key that is used for authentication performed with a terminal that uses the template key and the package data being in a data format that allows restoration only by the key storage device, a key information storage unit for restoring the template key and the authentication key, and for storing the template key and the authentication key in a tamper resistant non-volatile memory, a authentication unit for performing, in case a request for use of the template key is received from the terminal, authentication with the terminal by using authentication information that is based on the authentication key, and a key state management unit for placing, in case the authentication succeeds, the template key in a state usable by the terminal.

### BACKGROUND OF THE INVENTION

1. Field of the Invention

The present invention relates to a key storage device, a biometric authentication device, a biometric authentication system, a key management method, a biometric authentication method, and a program.

2. Description of the Related Art

In recent years, the value and importance of information held by an individual are rapidly increasing with the development of the information society. Under such circumstances, a biometric authentication technology (biometric technology) is drawing attention as a method of realizing secure information management. The biometric authentication is identification of oneself or of others using a characteristic part of a human body (living body) (hereinafter, a body part). For example, fingerprints are different for different living bodies, and thus fingerprints can be used for the biometric authentication. Similarly to the fingerprint, a voiceprint, the shape of a face, the shape of a hand, the iris pattern, a vein pattern, or the like, of a human also possesses different characteristics for different living bodies. Thus, by using these characteristics for the biometric authentication, it is possible to identify an individual or to perform an authentication process, a search process, or the like.

As described, to identify an individual or to perform an authentication process, a search process, or the like, by using the biometric authentication, it is necessary to compare the characteristics obtained from a body part. Thus, the characteristics of a body part (for example, a fingerprint, a voiceprint, a vein pattern, or the like) are obtained in a form of data (for example, image data, audio data, three-dimensional coordinate data, an iris code, or the like) for which comparison is possible. Then, a “template” that one registered in such a form in advance and “input data” that is input at the time of authentication operation are compared by some method, and a similarity is measured. Then, identification of an individual or authentication process or the like is performed based on the similarity obtained as a result of the comparison.

With regard to the biometric authentication, JP-A-2008-102780 discloses a technology for distinguishing whether a body pattern detected by an biometric authentication sensor belongs to a living body or a non-living body before performing authentication of a person based on a biometric pattern. Particularly, this patent document discloses a technology for distinguishing between a living body and a non-living body by grasping a unique statistical trend seen in a living body pattern. For example, a blood vessel pattern of a living body is inclined to be aligned along a certain direction. With regard to this trend, this patent document proposes a method of distinguishing between the living body pattern and the non-living body pattern based on the spread of the angle distribution, the intensity of the angle distribution, or the like, for each segment forming the blood vessel pattern, and of removing a pseudo blood vessel pattern or the like according to the result of distinguishing. Also, JP-A-2009-75950 discloses a method of efficiently managing information, such as a template, that is used for biometric authentication.

### SUMMARY OF THE INVENTION

It is true that using the biometric authentication method described in JP-A-2008-102780 enables to perform biometric authentication with higher accuracy. Also, using the management method described in JP-A-2009-75950 enables to efficiently manage information, such as a template, that is used for biometric authentication. However, according to the biometric authentication system described in JP-A-2009-75950, the template is stored in a biometric authentication device that is used at the time of performing biometric authentication (refer to FIG. 1, for example). Accordingly, when there is a plurality of biometric authentication devices, a user has to register the biometric information in each of the biometric authentication devices. When there are various services, such as a banking service, an entry/exit management service, or the like, and a biometric authentication device is installed for each service, the user has to register the biometric information in the biometric authentication device for each service.

In the future, biometric authentication characterized by high security and high authentication accuracy is expected to be widely used for various services. In addition to the banking service and the entry/exit management service that are already mentioned, it may also be used for user authentication for the use of a photocopier or a vending machine provided as a service in offices. However, if the user is to register the biometric information in each biometric authentication device, the burden on the user regarding the registration will be too heavy, and realistically, the utilization will be very hard. As a method of solving such issue, a method can be conceived of constructing a system where a template is encrypted and stored in an external server or the like, and every time a user is to receive a service, each biometric authentication device accesses the server or the like.

In the case of applying such system, a method of securely managing a template encryption key for decrypting a template becomes necessary as a matter of course. For example, with a system configuration where a template encryption key is shared by all the services, if the template encryption key is exposed by a biometric authentication device for a service, all the services will be used fraudulently. As such, a technology is desired, that is for securely managing a template for biometric authentication while providing high convenience for a user in a situation where the biometric authentication technology is used for various services.

In light of the foregoing, it is desirable to provide a key storage device, a biometric authentication device, a biometric authentication system, a key management method, a biometric authentication method, and a program, which are novel and improved, and which are capable of improving convenience for a user while maintaining security for an encrypted template that is held outside the biometric authentication device by using a tamper resistant device possessed by the user and appropriately managing a template encryption key for each service.

According to an embodiment of the present invention, there is provided a key storage device which includes a receiving unit for receiving package data that includes a template encryption key for decrypting an encrypted template for biometric authentication and an authentication key that is used for mutual authentication performed with a terminal that uses the template encryption key, the mutual authentication being performed at a time of placing the template encryption key in a usable state and the package data being in a data format that allows restoration only by the key storage device in which the template encryption key is stored, a key information storage unit for restoring the template encryption key and the authentication key from the package data received by the receiving unit, and for storing the template encryption key and the authentication key in a tamper resistant non-volatile memory, a mutual authentication unit for performing, in case a request for use of the template encryption key is received from the terminal, mutual authentication with the terminal by using authentication information that is based on the authentication key stored in the non-volatile memory, and a key state management unit for placing, in case the mutual authentication by the mutual authentication unit succeeds, the template encryption key stored in the non-volatile memory in a state usable by the terminal.

A system authentication key that is used for mutual authentication performed with the terminal at a time of the template encryption key and the authentication key being stored by the key information storage unit may be stored in advance in the non-volatile memory. The key storage device may further include a system mutual authentication unit for performing mutual authentication with the terminal by using the system authentication key stored in advance in the non-volatile memory. In case the mutual authentication by the system mutual authentication unit succeeds, the key information storage unit may restore the template encryption key and the authentication key from the package data and store the template encryption key and the authentication key in the non-volatile memory.

The key storage device may further include a system degenerate key generation unit for generating a system degenerate key from the system authentication key by using a specific system degenerate key generation function. The system mutual authentication unit may perform mutual authentication with the terminal by using the system degenerate key generated by the system degenerate key generation unit.

The key storage device may further include a degenerate key generation unit for generating a degenerate key from the authentication key by using a specific degenerate key generation function. The mutual authentication unit may perform mutual authentication with the terminal by using the degenerate key generated by the degenerate key generation unit.

In case a request for use of a plurality of template encryption keys is received from the terminal in a state where a plurality of services exist, where the template encryption key is set for each of the services, and where the template encryption keys and authentication keys corresponding to the plurality of services are stored in the non-volatile memory, the degenerate key generation unit may generate one degenerate key by using the authentication keys corresponding to the plurality of services in relation to which the request for use has been received, the mutual authentication unit may perform mutual authentication with the terminal by using the one degenerate key generated by the degenerate key generation unit, and the key state management unit may place, in case the mutual authentication by the mutual authentication unit succeeds, a plurality of template encryption keys that correspond to the plurality of services in relation to which the request for use has been received and that are stored in the non-volatile memory in a state usable by the terminal.

In case the mutual authentication by the mutual authentication unit succeeds, the key state management unit may copy, in a volatile memory, the template encryption key stored in the non-volatile memory, and place the template encryption key in the volatile memory in a state usable by the terminal while a session with the terminal is established.

According to another embodiment of the present invention, there is provided a biometric authentication device which includes a biometric information acquisition unit for capturing an image of a biometric pattern, and for acquiring biometric information for biometric authentication, an encrypted template acquisition unit for acquiring an encrypted template for biometric authentication, a mutual authentication unit for acquiring authentication information that is used at a time of performing mutual authentication with a key storage device that stores a template encryption key for decrypting the encrypted template for biometric authentication in a tamper resistant non-volatile memory and that manages the template encryption key, and for performing mutual authentication with the key storage device by using the authentication information, a template decryption unit for decrypting the encrypted template for biometric authentication by using the template encryption key, in case the mutual authentication by the mutual authentication unit succeeds and the template encryption key is placed in a usable state by the key storage device, and a biometric authentication unit for performing a biometric authentication process by checking, against each other, the template for biometric authentication decrypted by the template decryption unit and the biometric information acquired by the biometric information acquisition unit.

The biometric authentication device may further include a system mutual authentication unit for acquiring system authentication information to be used for mutual authentication that is performed at a time of storing the template encryption key in the non-volatile memory of the key storage device, and for performing mutual authentication with the key storage device by using the system authentication information, and a package data providing unit for acquiring package data that includes the template encryption key along with an authentication key used for mutual authentication performed at a time of the key storage device placing the template encryption key in a usable state and that is in a data format that allows restoration only by the key storage device, and for providing the package data to the key storage device, in case the mutual authentication by the system mutual authentication unit succeeds.

According to another embodiment of the present invention, there is provided a biometric authentication system which includes a key storage device including a receiving unit for receiving package data that includes a template encryption key for decrypting an encrypted template for biometric authentication and an authentication key that is used for mutual authentication performed with a biometric authentication device that uses the template encryption key, the mutual authentication being performed at a time of placing the template encryption key in a usable state and the package data being in a data format that allows restoration only by the key storage device in which the template encryption key is stored, a key information storage unit for restoring the template encryption key and the authentication key from the package data received by the receiving unit, and for storing the template encryption key and the authentication key in a tamper resistant non-volatile memory, a first mutual authentication unit for performing, in case a request for use of the template encryption key is received from the biometric authentication device, mutual authentication with the biometric authentication device by using authentication information that is based on the authentication key stored in the non-volatile memory, and a key state management unit for placing, in case the mutual authentication by the first mutual authentication unit succeeds, the template encryption key stored in the non-volatile memory in a state usable by the biometric authentication device, and the biometric authentication device including a biometric information acquisition unit for capturing an image of a biometric pattern, and for acquiring biometric information for biometric authentication, an encrypted template acquisition unit for acquiring the encrypted template for biometric authentication, a second mutual authentication unit for acquiring authentication information that is used at a time of performing mutual authentication with the key storage device, and for performing mutual authentication with the key storage device by using the authentication information, a template decryption unit for decrypting the encrypted template for biometric authentication by using the template encryption key, in case the mutual authentication by the second mutual authentication unit succeeds and the template encryption key is placed in a usable state by the key storage device, and a biometric authentication unit for performing a biometric authentication process by checking, against each other, the template for biometric authentication decrypted by the template decryption unit and the biometric information acquired by the biometric information acquisition unit.

According to another embodiment of the present invention, there is provided a key management method which includes the steps of receiving package data that includes a template encryption key for decrypting an encrypted template for biometric authentication and an authentication key that is used for mutual authentication performed with a terminal that uses the template encryption key, the mutual authentication being performed at a time of placing the template encryption key in a usable state and the package data being in a data format that allows restoration only by a key storage device in which the template encryption key is stored, restoring the template encryption key and the authentication key from the package data received in the step of receiving, and storing the template encryption key and the authentication key in a tamper resistant non-volatile memory, performing, in case a request for use of the template encryption key is received from the terminal, mutual authentication with the terminal by using authentication information that is based on the authentication key stored in the non-volatile memory, and placing, in case the mutual authentication succeeds in the step of performing mutual authentication, the template encryption key stored in the non-volatile memory in a state usable by the terminal.

According to another embodiment of the present invention, there is provided a biometric authentication method which includes the steps of capturing an image of a biometric pattern, and acquiring biometric information for biometric authentication, acquiring an encrypted template for biometric authentication, acquiring authentication information that is used at a time of performing mutual authentication with a key storage device that stores a template encryption key for decrypting the encrypted template for biometric authentication in a tamper resistant non-volatile memory and that manages the template encryption key, and performing mutual authentication with the key storage device by using the authentication information, decrypting the encrypted template for biometric authentication by using the template encryption key, in case the mutual authentication succeeds in the step of performing mutual authentication and the template encryption key is placed in a usable state by the key storage device, and performing a biometric authentication process by checking, against each other, the template for biometric authentication decrypted in the step of decrypting and the biometric information acquired in the step of acquiring biometric information.

According to another embodiment of the present invention, there is provided a biometric authentication method which includes the steps of receiving, by a key storage device provided with a tamper resistant non-volatile memory in which a template encryption key is stored, package data that includes a template encryption key for decrypting an encrypted template for biometric authentication and an authentication key that is used for mutual authentication performed with a biometric authentication device that uses the template encryption key, the mutual authentication being performed at a time of placing the template encryption key in a usable state and the package data being in a data format that allows restoration only by the key storage device, restoring, by the key storage device, the template encryption key and the authentication key from the package data received in the step of receiving and storing, by the key storage device, the template encryption key and the authentication key in a tamper resistant non-volatile memory, performing, by the key storage device, mutual authentication with the biometric authentication device by using authentication information that is based on the authentication key stored in the non-volatile memory, in case a request for use of the template encryption key is received from the biometric authentication device, placing, by the key storage device, the template encryption key stored in the non-volatile memory in a state usable by the biometric authentication device, in case the mutual authentication succeeds in the step of performing mutual authentication with the biometric authentication device, capturing, by the biometric authentication device, an image of a biometric pattern and acquiring, by the biometric authentication device, biometric information for biometric authentication, acquiring, by the biometric authentication device, the encrypted template for biometric authentication, acquiring, by the biometric authentication device, authentication information that is used at a time of performing mutual authentication with the key storage device and performing, by the biometric authentication device, mutual authentication with the key storage device by using the authentication information, decrypting, by the biometric authentication device, the encrypted template for biometric authentication by using the template encryption key, in case the mutual authentication succeeds in the step of performing mutual authentication with the key storage device and the template encryption key is placed in a usable state by the key storage device, and performing, by the biometric authentication device, a biometric authentication process by checking, against each other, the template for biometric authentication decrypted in the step of decrypting and the biometric information acquired in the step of acquiring biometric information.

According to another embodiment of the present invention, there is provided a program for causing a computer to realize a receiving function of receiving package data that includes a template encryption key for decrypting an encrypted template for biometric authentication and an authentication key that is used for mutual authentication performed with a terminal that uses the template encryption key, the mutual authentication being performed at a time of placing the template encryption key in a usable state and the package data being in a data format that allows restoration only by a key storage device in which the template encryption key is stored, a key information storage function of restoring the template encryption key and the authentication key from the package data received by the receiving function, and of storing the template encryption key and the authentication key in a tamper resistant non-volatile memory, a mutual authentication function of performing, in case a request for use of the template encryption key is received from the terminal, mutual authentication with the terminal by using authentication information that is based on the authentication key stored in the non-volatile memory, and a key state management function of placing, in case the mutual authentication by the mutual authentication function succeeds, the template encryption key stored in the non-volatile memory in a state usable by the terminal.

According to another embodiment of the present invention, there is provided a program for causing a computer to realize a biometric information acquisition function of capturing an image of a biometric pattern, and of acquiring biometric information for biometric authentication, an encrypted template acquisition function of acquiring an encrypted template for biometric authentication, a mutual authentication function of acquiring authentication information that is used at a time of performing mutual authentication with a key storage device that stores a template encryption key for decrypting the encrypted template for biometric authentication in a tamper resistant non-volatile memory and that manages the template encryption key, and of performing mutual authentication with the key storage device by using the authentication information, a template decryption function of decrypting the encrypted template for biometric authentication by using the template encryption key, in case the mutual authentication by the mutual authentication function succeeds and the template encryption key is placed in a usable state by the key storage device, and a biometric authentication function of performing a biometric authentication process by checking, against each other, the template for biometric authentication decrypted by the template decryption function and the biometric information acquired by the biometric information acquisition function.

According to another embodiment of the present invention, there is provided a recording medium in which the program is recorded, the recording medium being able to be read by a computer.

According to the embodiments of the present invention described above, security for an encrypted template that is held outside the biometric authentication device can be maintained by using a tamper resistant device possessed by a user and appropriately managing a template encryption key for each service, and at the same time, the convenience for user can be improved.

### BRIEF DESCRIPTION OF THE DRAWINGS

FIG. 1 is an explanatory diagram showing a configuration example of a general biometric authentication device;

FIG. 2 is an explanatory diagram showing an example of an overall system configuration of a biometric authentication system according to an embodiment of the present invention;

FIG. 3 is an explanatory diagram showing an example of an overall system configuration of a biometric authentication system according to a modified example of the embodiment;

FIG. 4 is an explanatory diagram schematically showing a configuration of service data stored in a non-volatile memory on a secure chip according to the embodiment;

FIG. 5 is an explanatory diagram schematically showing a data configuration of service data stored in a non-volatile memory on a secure chip according to the embodiment;

FIG. 6 is an explanatory diagram showing an example of a functional configuration of a PC (a service registration terminal, a biometric authentication device) according to the embodiment;

FIG. 7 is an explanatory diagram showing an example of a functional configuration of a secure device according to the embodiment;

FIG. 8 is an explanatory diagram showing an example of a functional configuration of a service data management system according to the embodiment;

FIG. 9 is an explanatory diagram showing a flow of a service registration process according to the embodiment;

FIG. 10 is an explanatory diagram showing a flow of an activation process of a system service according to the embodiment;

FIG. 11 is an explanatory diagram showing concrete contents of the activation process of a system service according to the embodiment;

FIG. 12 is an explanatory diagram showing in a table format the concrete contents of the activation process of a system service, types of authentication keys used in the process, and information on arguments used at the time of performing the process according to the embodiment;

FIG. 13 is an explanatory diagram showing in a table format a concrete configuration of a signal processing function used for the activation process of a system service according to the embodiment;

FIG. 14 is an explanatory diagram showing a flow of an activation process of a general service according to the embodiment;

FIG. 15 is an explanatory diagram showing concrete contents of the activation process of a general service according to the embodiment;

FIG. 16 is an explanatory diagram showing a flow of a simultaneous activation process of a plurality of services according to the embodiment;

FIG. 17 is an explanatory diagram showing concrete contents of the flow of the simultaneous activation process of a plurality of services according to the embodiment;

FIG. 18 is an explanatory diagram showing concrete contents of a process of simultaneously activating services of a plurality of versions according to the embodiment;

FIG. 19 is an explanatory diagram showing in a table format the concrete contents of the activation process of a general service, types of authentication keys used in the process, and information on arguments used at the time of performing the process according to the embodiment;

FIG. 20 is an explanatory diagram showing in a table format a concrete configuration of a signal processing function used for the activation process of a general service according to the embodiment;

FIG. 21 is an explanatory diagram showing an example of a functional configuration of a biometric authentication device according to the embodiment;

FIG. 22 is an explanatory diagram showing an example of a functional configuration of a template management system according to the embodiment;

FIG. 23 is an explanatory diagram showing an overall flow of a biometric authentication process according to the embodiment;

FIG. 24 is an explanatory diagram showing concrete contents of a service change process according to the embodiment;

FIG. 25 is an explanatory diagram showing a flow of the service change process according to the embodiment;

FIG. 26 is an explanatory diagram showing a flow of service deletion process according to the embodiment;

FIG. 27 is an explanatory diagram showing an example of a functional configuration of a template registration terminal according to the embodiment;

FIG. 28 is an explanatory diagram showing a flow of a template registration process according to the embodiment;

FIG. 29 is an explanatory diagram showing a flow of a template encryption key exchange process according to the embodiment; and

FIG. 30 is an explanatory diagram showing an example of a hardware configuration of an information processing apparatus capable of realizing functions of each device and system according to the embodiment.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### <Flow of Description>

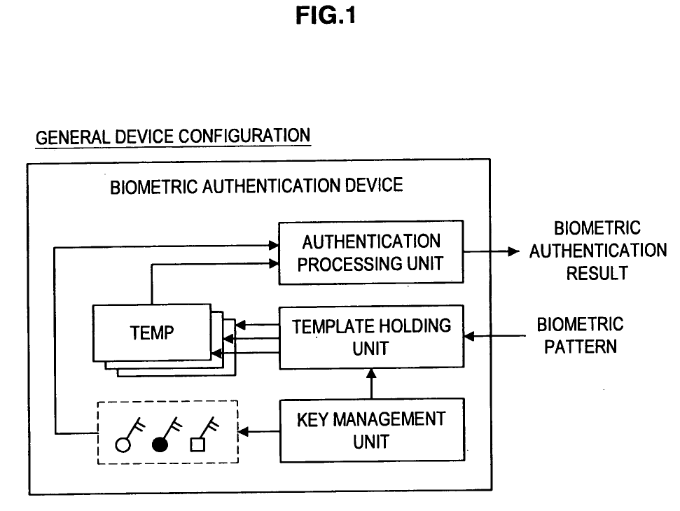

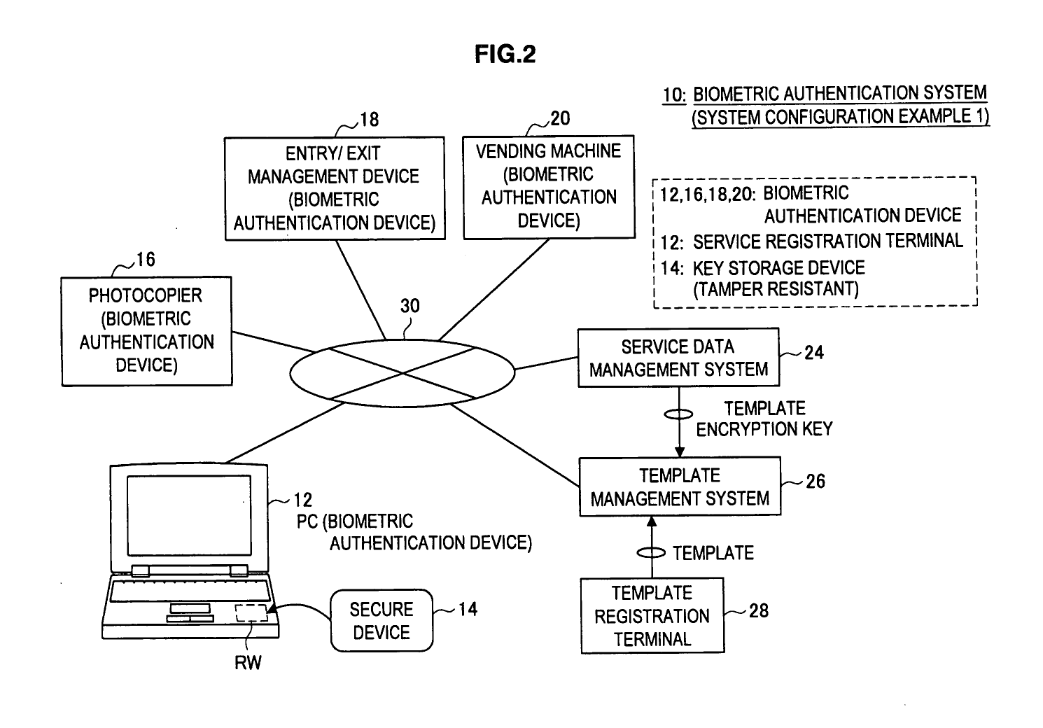

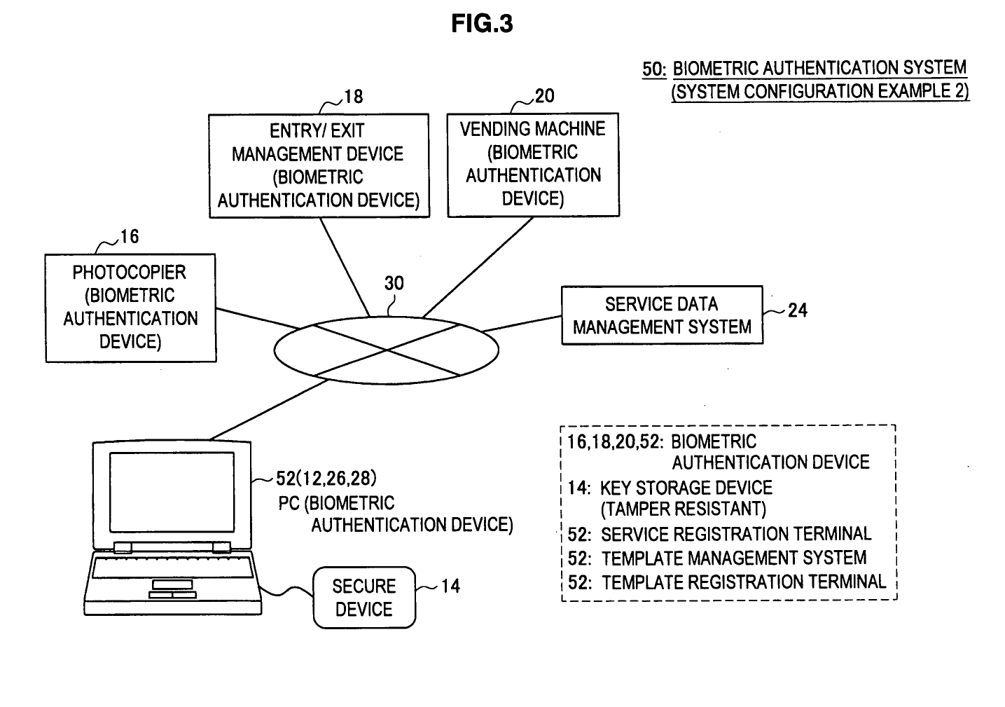

The flow of a description of an embodiment of the present invention described below will be briefly mentioned here. First, the configuration of a general biometric authentication device will be described with reference to FIG. 1. Then, the overall system configuration of a biometric authentication system according to the present embodiment will be described with reference to FIG. 2, in comparison with the configuration of the biometric authentication device shown in FIG. 1. Furthermore, the overall system configuration of a biometric authentication system according to a modified example of the present embodiment will be described with reference to FIG. 3.

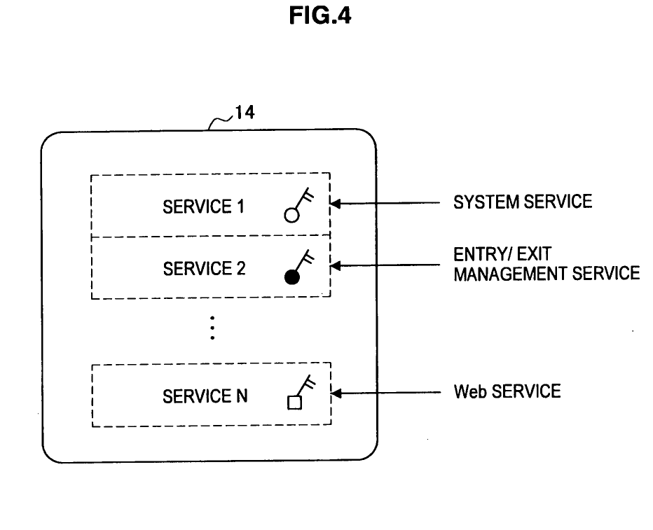

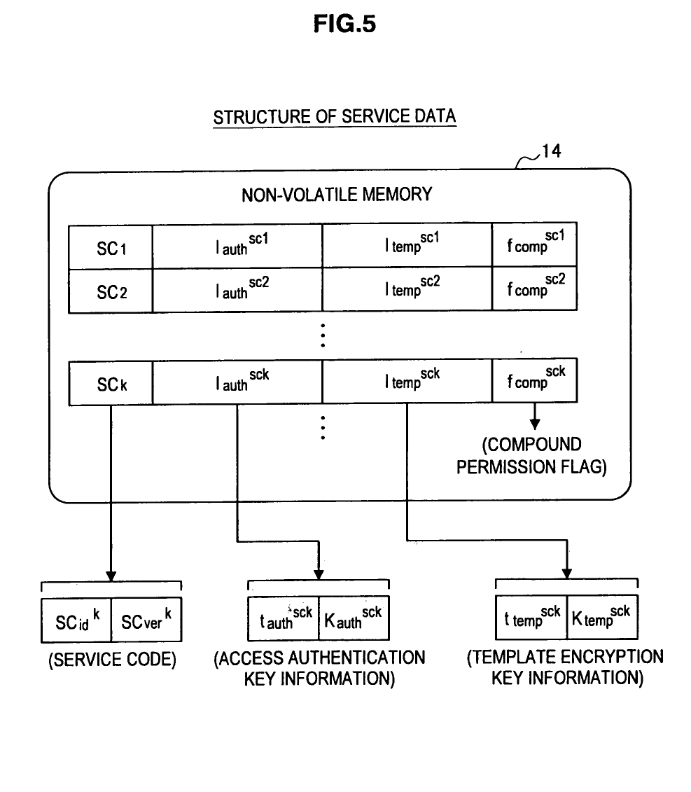

Then, the configuration of a secure device included in the biometric authentication system of the present embodiment will be described with reference to FIGS. 4 and 5. Therein, an explanation will be given, with reference to FIG. 4, on a management method for a template encryption key used for decrypting the original template from an encrypted template. Furthermore, an explanation will be given, with reference to FIG. 5, on the contents of service data stored in a non-volatile memory provided in the secure device, and the data structure of the service data.

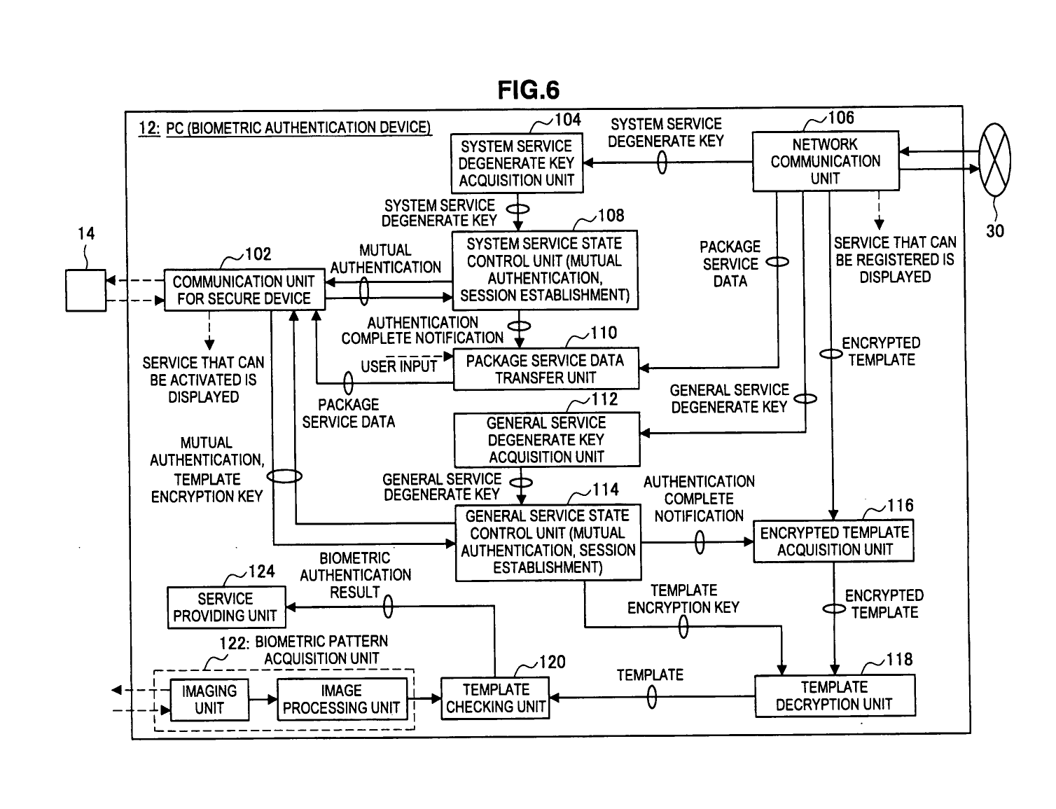

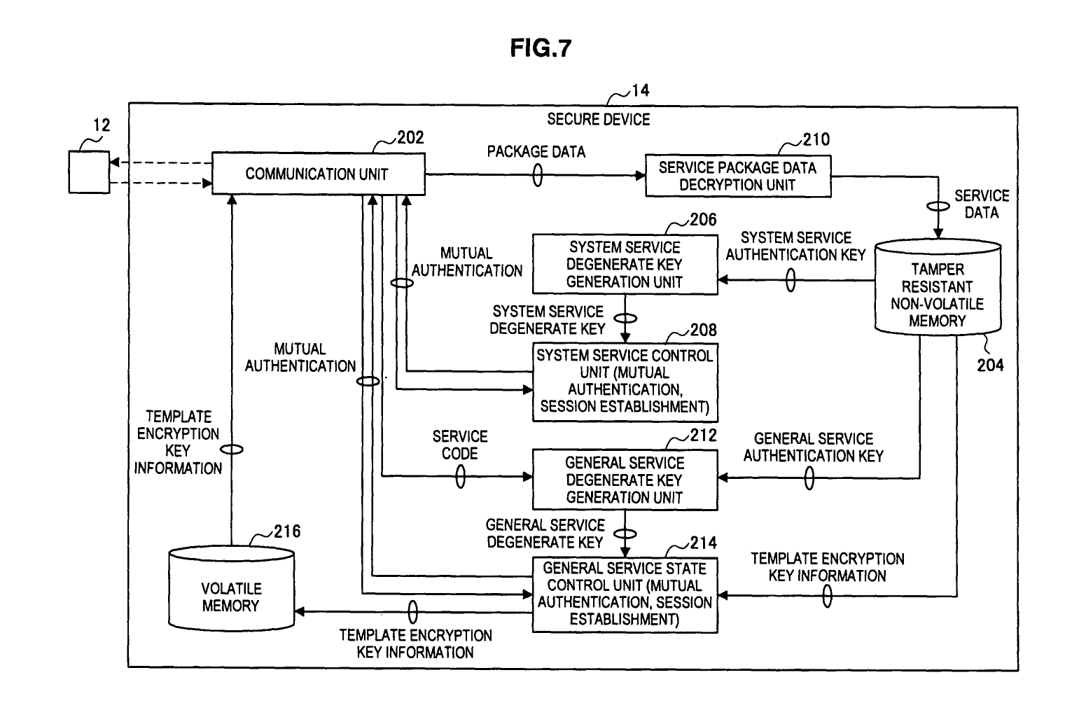

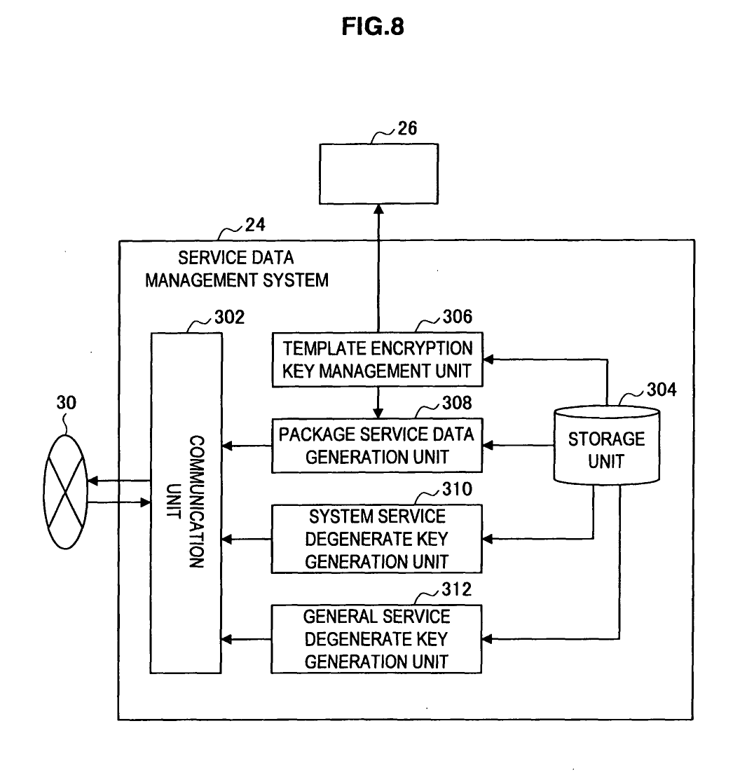

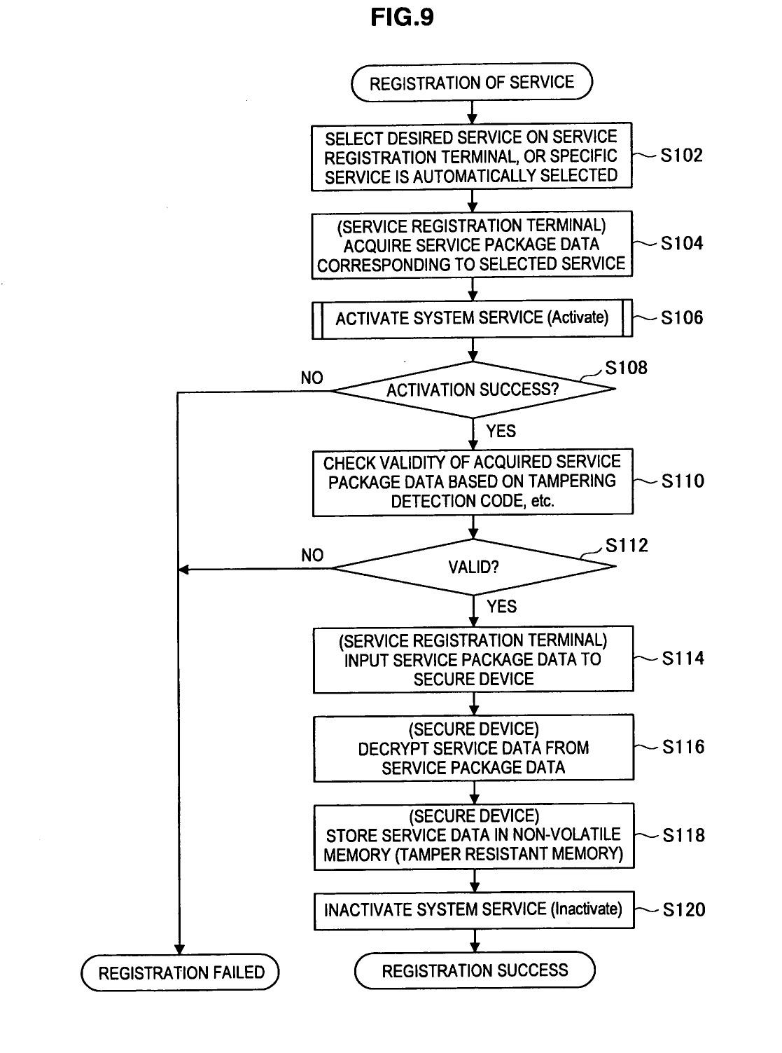

Next, the functional configuration of a PC that functions as a service registration terminal and also as the biometric authentication device in the biometric authentication system of the present embodiment will be described with reference to FIG. 6. However, only the main structural elements for providing the function of the service registration terminal will be described in detail here. Then, the functional configuration of the secure device included in the biometric authentication system of the present embodiment will be described with reference to FIG. 7. However, only the main structural elements for providing the function that is used at the time of service registration will be described in detail here. Next, the functional configuration of a service data management system included in the biometric authentication system of the present embodiment will be described with reference to FIG. 8. However, only the main structural elements for providing the function that is used at the time of service registration will be described in detail here. Next, the flow of a service registration process according to the present embodiment will be described with reference to FIGS. 9 to 13.

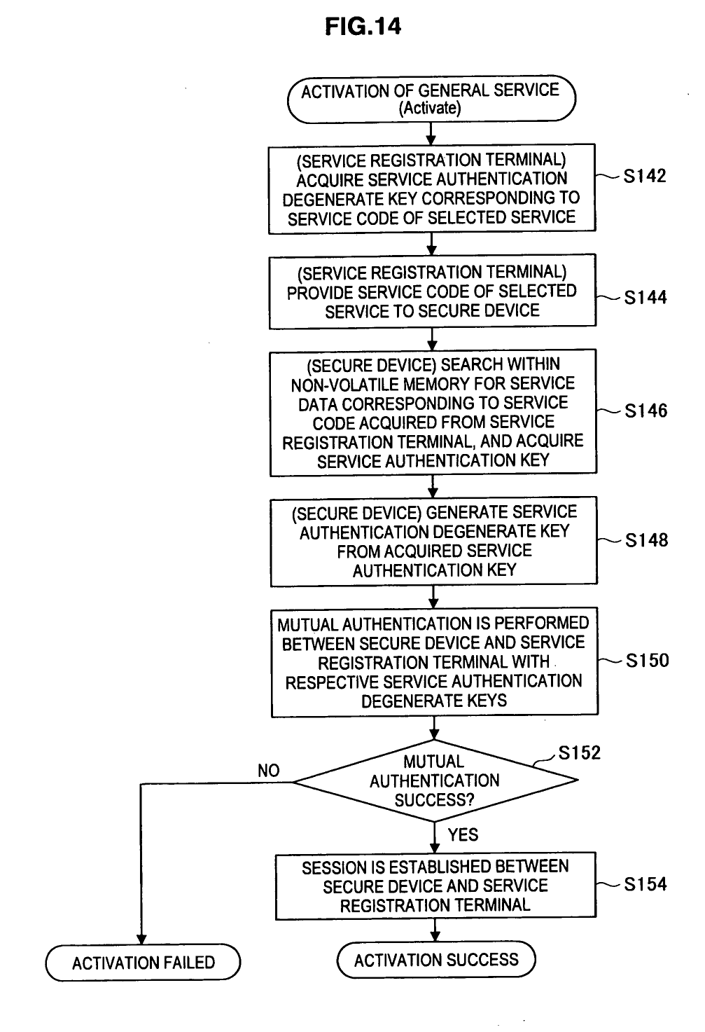

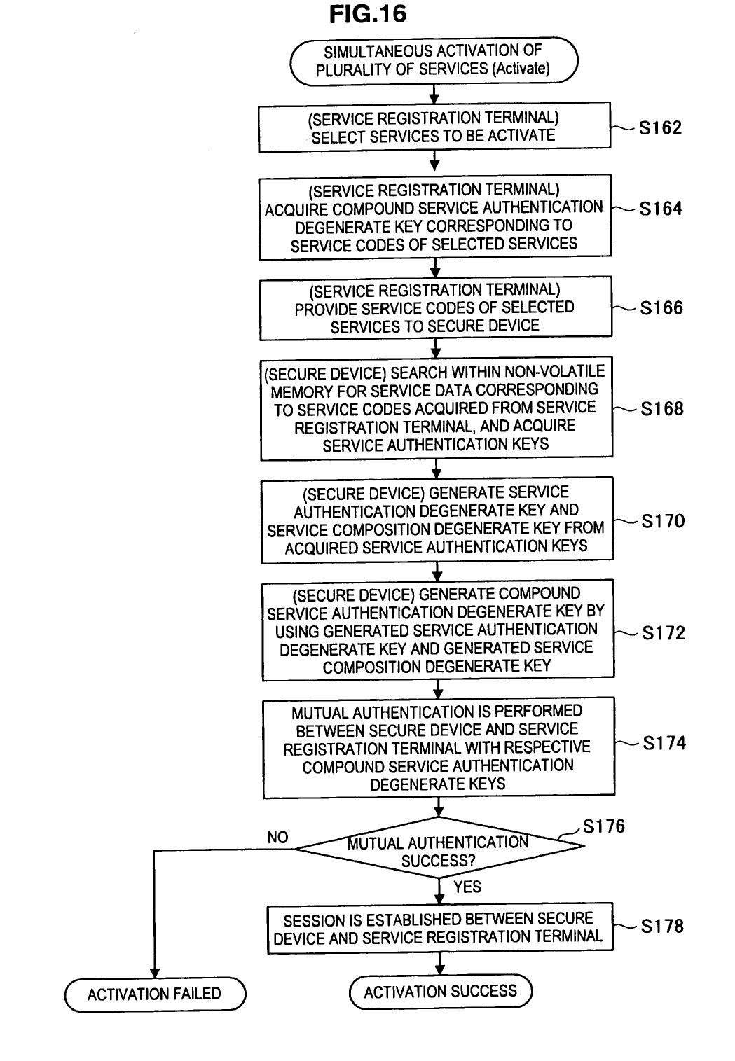

Then, referring again to FIG. 6, the functions of the main structural elements for providing a service activation function will be described in relation to the functional configuration of the PC included in the biometric authentication system of the present embodiment. Next, referring again to FIG. 7, the functions of the main structural elements for providing the service activation function will be described in relation to the functional configuration of the secure device included in the biometric authentication system of the present embodiment. Next, referring again to FIG. 8, the functions of the main structural elements for providing the service activation function will be described in relation to the service data management system included in the biometric authentication system of the present embodiment. Next, the flow of a service activation process according to the present embodiment will be described with reference to FIGS. 14, 15, 19, and 20. Next, the flow of a simultaneous activation process of a plurality of services (combined activation) according to the present embodiment will be described with reference to FIGS. 16 to 20.

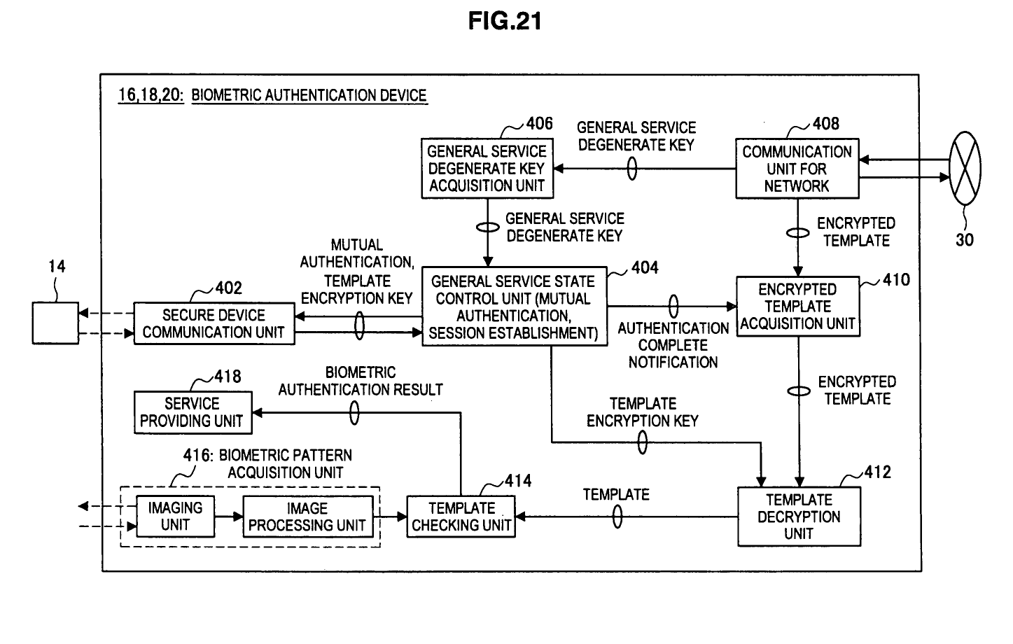

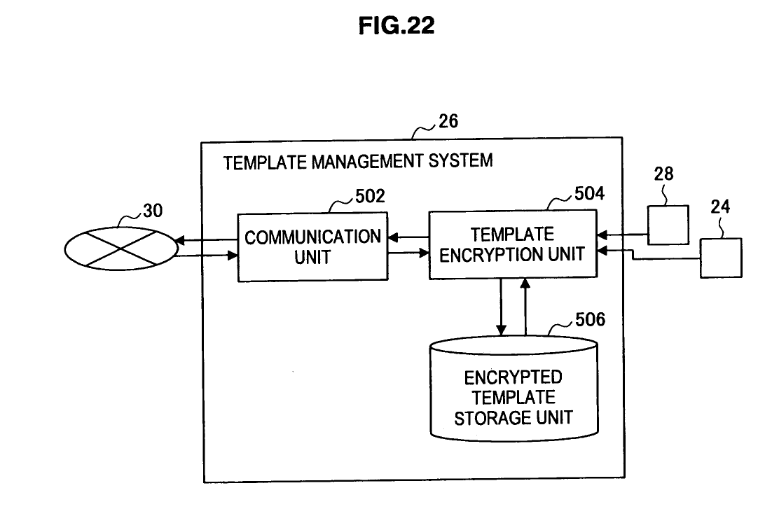

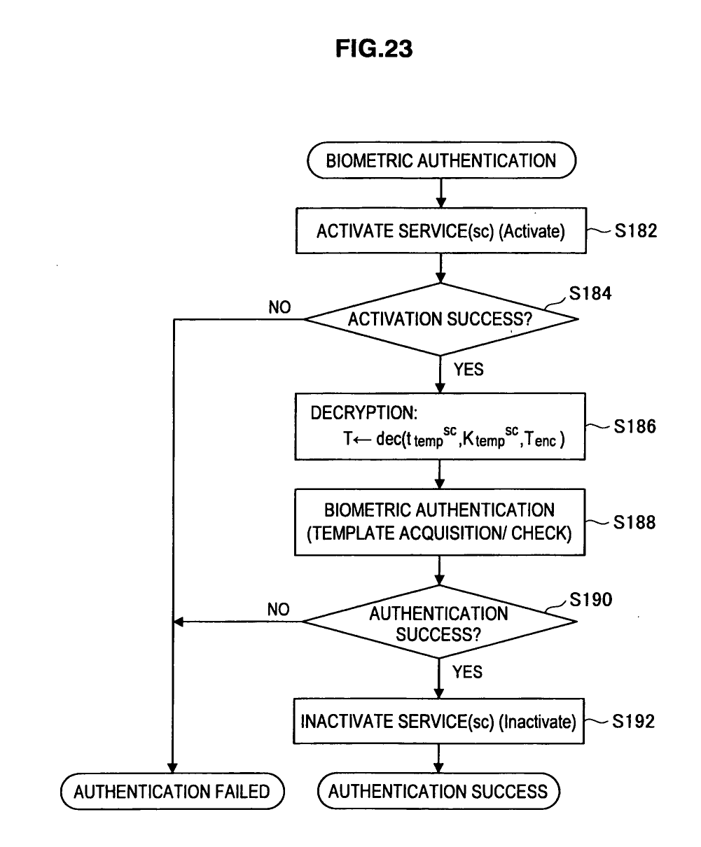

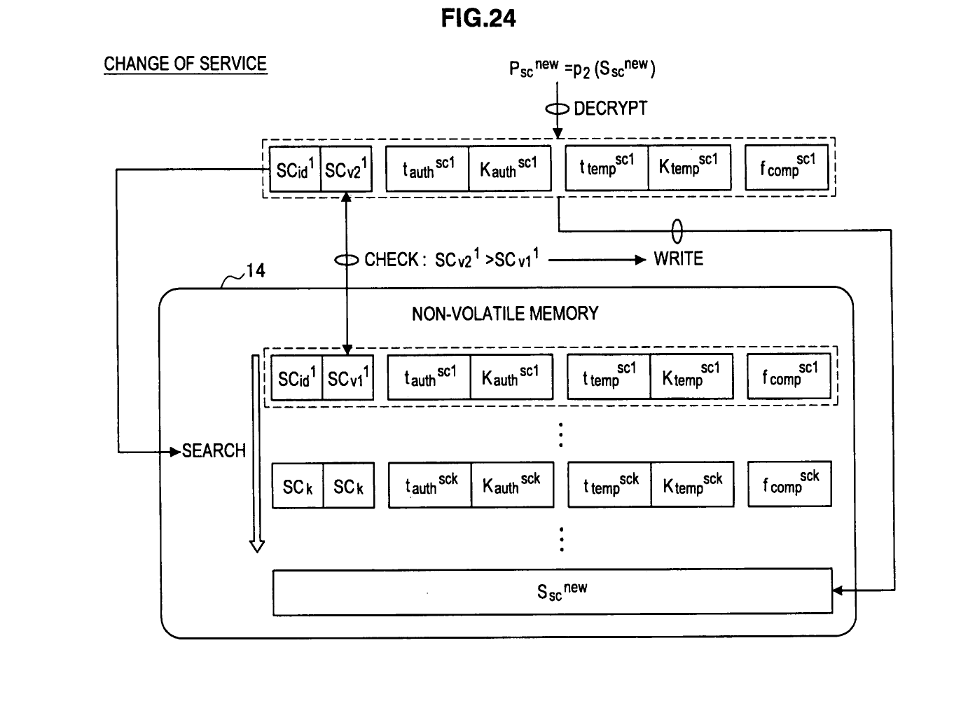

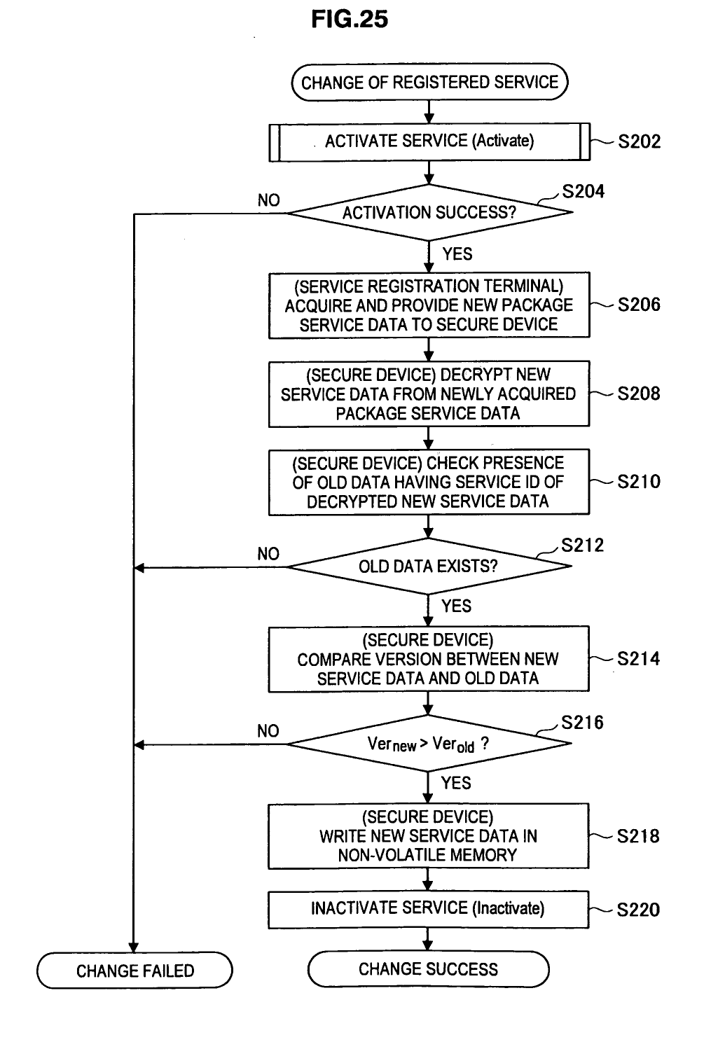

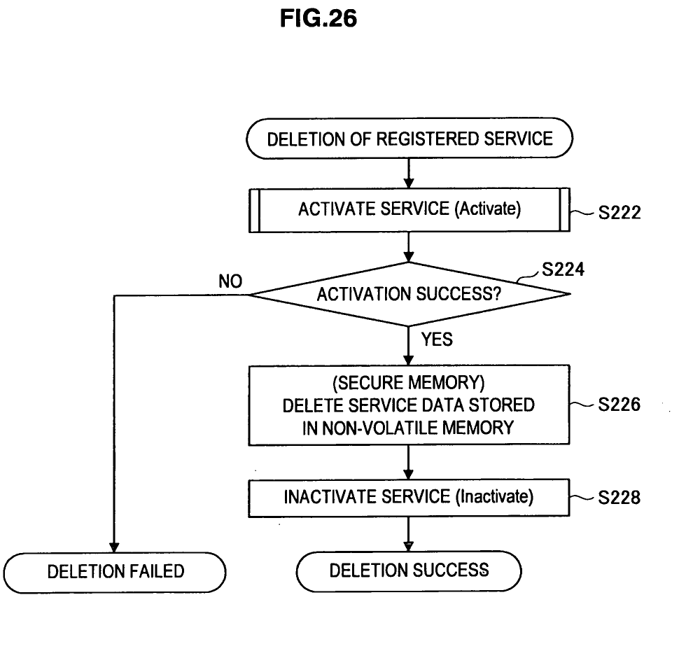

Next, referring again to FIG. 6, the functions of the main structural elements for providing the function of the biometric authentication device will be described in relation to the functional configuration of the PC included in the biometric authentication system of the present embodiment. Next, the functional configuration of the biometric authentication device included in the biometric authentication system of the present embodiment will be described with reference to FIG. 21. Then, the functional configuration of a template management system included in the biometric authentication system of the present embodiment will be described with reference to FIG. 22. Then, the flow of the biometric authentication process according to the present embodiment will be described with reference to FIG. 23. Then, the flow of a service change process according to the present embodiment will be described with reference to FIGS. 24 and 25. Then, the flow of a service deletion process according to the present embodiment will be described with reference to FIG. 26.

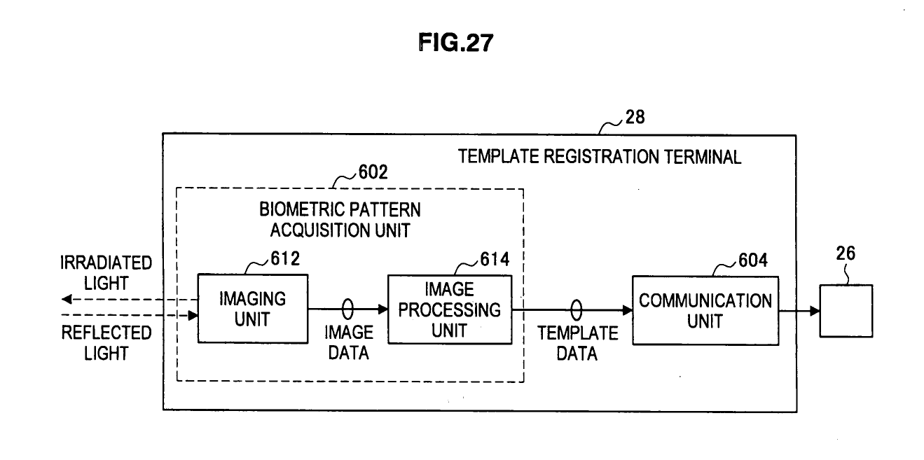

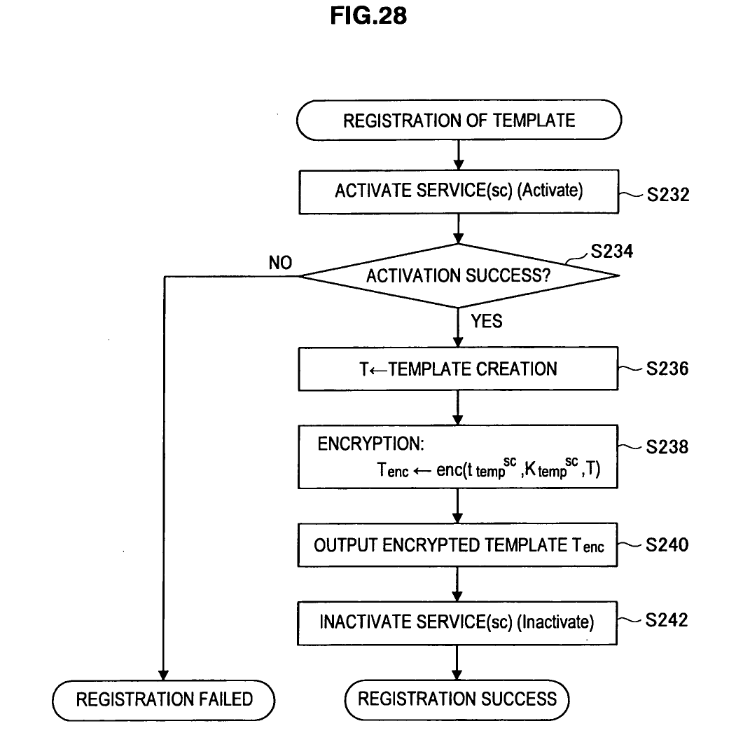

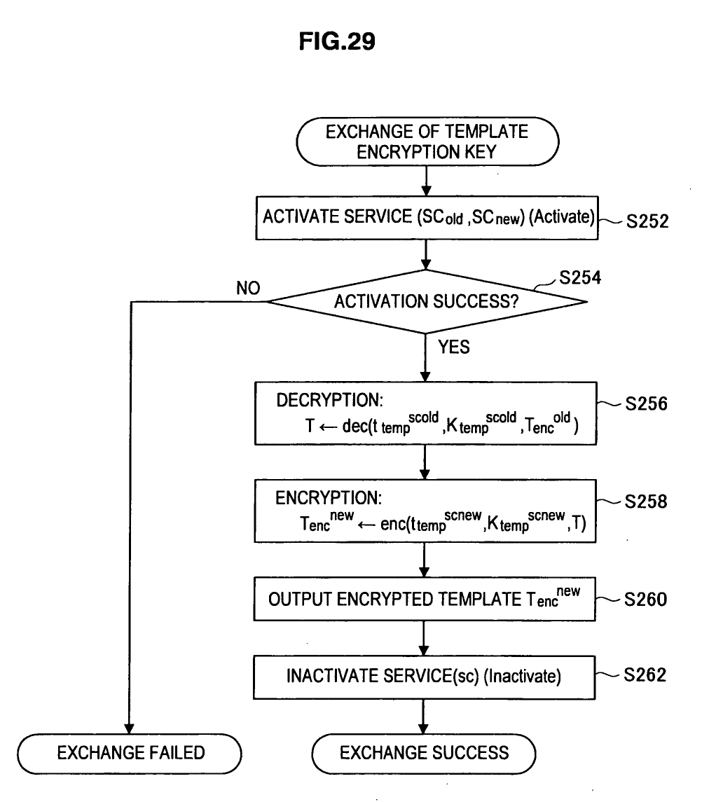

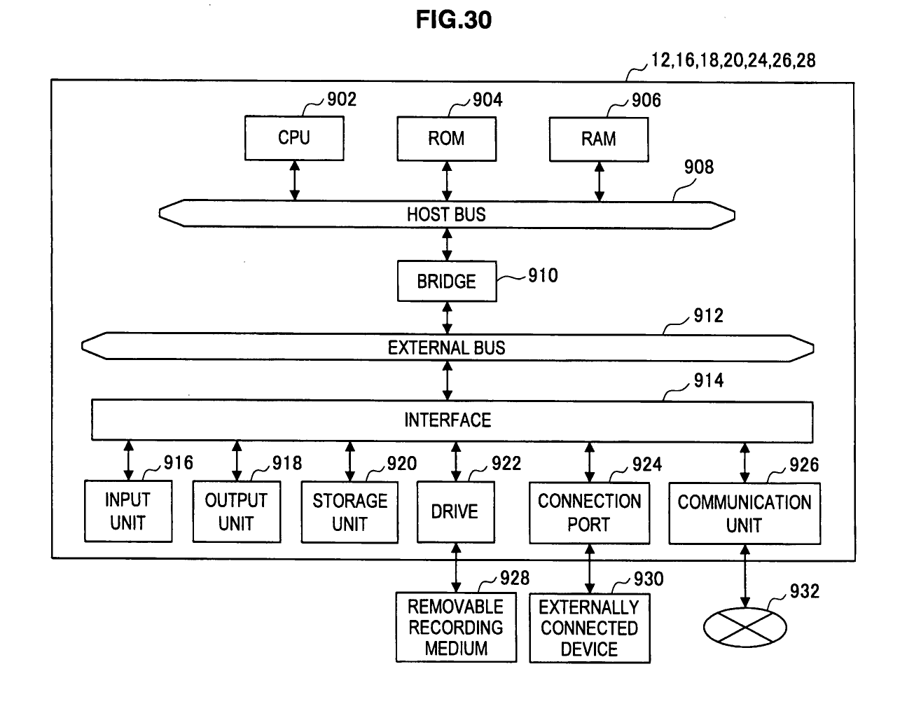

Then, the functional configuration of a template registration terminal included in the biometric authentication system of the present embodiment will be described with reference to FIG. 27. Then, the flow of a template registration process according to the present embodiment will be described with reference to FIG. 28. Then, the flow of a template encryption key exchange process according to the present embodiment will be described with reference to FIG. 29. Then, an example of the hardware configuration of an information processing apparatus that is capable of realizing functions of each device included in the biometric authentication system and of the system according to the present embodiment will be described with reference to FIG. 30.

### (Description Items)

1: Overall System Configuration of Biometric Authentication System

1-1: System Configuration Example 1 (Configuration for Storing Template in Server)

1-2: System Configuration Example 2 (Configuration for Storing Template in PC)

2: Configuration of Secure Device

2-1: Data Structure within Non-Volatile Memory

3: Service Registration

3-1: Functional Configuration of PC (Service Registration Function Part)

3-2: Functional Configuration of Secure Device (Service Registration Function Part)

3-3: Functional Configuration of Service Data Management System (Service Registration Function Part)

3-4: Flow of Service Registration Process

3-4-1: Overall Process Flow

3-4-2: Flow of System Service Activation Process

4: Service Activation

4-1: Functional Configuration of PC (Service Activation Function Part)

4-2: Functional Configuration of Secure Device (Service Activation Function Part)

4-3: Functional Configuration of Service Data Management System (Service Activation Function Part)

4-4: Flow of Service Activation Process

4-5: Simultaneous Activation of a Plurality of Services

4-5-1: Simultaneous Activation of Different Services

4-5-2: Simultaneous Activation of Different Versions

5: Biometric Authentication

5-1: Functional Configuration of PC (Biometric Authentication Function Part)

5-2: Functional Configuration of Biometric Authentication Device

5-3: Functional Configuration of Template Management System (Biometric Authentication Function Part)

5-4: Flow of Biometric Authentication Process

6: Change/Deletion of Service

6-1: Flow of Service Change Process

6-2: Flow of Service Deletion Process

7: Template Registration

7-1: Functional Configuration of Template Registration Terminal

7-2: Flow of Template Registration Process

8: Exchange of Template Encryption Key

9: Hardware Configuration

### Embodiment

An embodiment of the present invention will be described. The present embodiment proposes a configuration of a biometric authentication system that allows a user to receive a desired service without the user having to register a template in each of biometric authentication devices, by managing a template that is used for biometric authentication outside the biometric authentication devices provided for respective services.

To describe in more detail, the present embodiment provides a biometric authentication system that takes security into consideration in such a way that even if the template encryption key of a service becomes exposed, other services will not be affected, by preparing a template encryption key for each service. Particularly, it relates to a technology for registering usable services in a secure device that is possessed by an individual user, and for performing control by using the registered information so as to allow a biometric authentication device for providing a desired service to use a template encryption key. A more detailed explanation will be given in the following using concrete examples.

### 1: Overall System Configuration of Biometric Authentication System

First, the overall system configuration of the biometric authentication system according to the present embodiment will be described. Two types of system configuration examples will be shown here as the concrete examples. However, it should be noted that the application scope of the technology according to the present embodiment is not limited to these two types of system configuration examples.

### 1-1: System Configuration Example 1 (Configuration for Storing Template in Server)

As a first example, a system configuration of a biometric authentication system 10 designed to store a template in a server (template management system 26) provided outside a biometric authentication device is shown in FIG. 2. FIG. 2 is an explanatory diagram showing an example of the system configuration of the biometric authentication system 10 according to the present embodiment.

As shown in FIG. 2, the biometric authentication system 10 mainly includes a PC 12, a secure device 14, a photocopier 16, an entry/exit management device 18, a vending machine 20, a service data management system 24, the template management system 26, and a template registration terminal 28.

Additionally, the PC 12, the photocopier 16, the entry/exit management device 18, and the vending machine 20 are examples of a device that provides a biometric authentication service, and are provided with the function of a biometric authentication device. Also, it is assumed that the PC 12 is provided with the function of a service registration terminal, in addition to the function of the biometric authentication device. Additionally, in the following explanation, the PC 12, the photocopier 16, the entry/exit management device 18, and the vending machine 20 may be expressed as the biometric authentication device. Also, the PC 12 may be expressed as the service registration terminal. The function of the service registration terminal will be described later.

It is assumed that the PC 12, the photocopier 16, the entry/exit management device 18, the vending machine 20, the service data management system 24, and the template management system 26 are connected via a network 30. It is also assumed that the PC 12 is provided with a reader/writer (R/W) for wirelessly communicating with the secure device 14. Thus, the PC 12 can write data in the secure device 14 or read data out of the secure device 14 via the reader/writer. Furthermore, the secure device 14 is an example of a key storage device that stores a template encryption key. The template encryption key and the configuration of the key storage device will be described later.

In the biometric authentication system 10 shown in FIG. 2, a template for biometric authentication is managed by the template management system 26. The template is created by using the template registration terminal 28, and is stored in the template management system 26. At this time, the template is encrypted with a specific template encryption key. In the following explanation, the template that has been encrypted will be referred to as an encrypted template. Furthermore, in the biometric authentication system 10 according to the present embodiment, the encrypted template is created for each service.

The example of FIG. 2 assumes a Web service that is provided by the PC 12, a photocopying service that is provided by the photocopier 16, an entry/exit management service that is provided by the entry/exit management device 18, and a vending service that is provided by the vending machine 20. Accordingly, an encrypted template for the Web service, an encrypted template for the photocopying service, an encrypted template for the entry/exit management service, and an encrypted template for the vending service are stored in the template management system 26. Each encrypted template is created by encrypting a template input from the template registration terminal 28 with a template encryption key different for each service, for example.

The template encryption key for each service is managed by the service data management system 24. Thus, the template encryption key is not held in the PC 12, the photocopier 16, the entry/exit management device 18, and the vending machine 20 so as to be able to be used at all times. That is, with the biometric authentication system 10, the encrypted template and the template encryption key are managed in a system provided outside the biometric authentication device.

Here, reference will be made to FIG. 1. As shown in FIG. 1, with a general biometric authentication device that has been widely used, the encrypted template and the template encryption key were managed in a secure device within the biometric authentication device. Thus, a user had to go to the place where the biometric authentication device for each service was installed and register a biometric pattern, and there was an issue that as the types of services increased, the burden on the user increased.

In view of such issue, a method is proposed with the biometric authentication system 10 to manage the template encryption key in the service data management system 24 and to manage the encrypted template in the template management system 26 (outsourcing of template management). When using this method, the user does not have to go to the installation location of the biometric authentication device corresponding to each service to register the template. However, to have the biometric authentication system 10 effectively function, a mechanism for appropriately controlling access to the encrypted template and the template encryption key while maintaining the convenience of the user becomes necessary.

According to the present embodiment, a method is used of controlling access to the template encryption key for each service by using mutual authentication between each biometric authentication device and the secure device 14 with the template encryption keys corresponding to desired services stored in the secure device 14. In the following, this method will be described in detail, but first, a modified example of the biometric authentication system 10 will be introduced.

### 1-2: System Configuration Example 2 (Configuration for Storing Template in PC)

According to the biometric authentication system 10 described above, the encrypted template is managed by the template management system 26. However, the present embodiment relates to a technology for controlling access to the template encryption key for each service by using mutual authentication between each biometric authentication device and the secure device 14 with the template encryption keys corresponding to desired services stored in the secure device 14.

Thus, system configuration modification is also possible according to which the encrypted template and the template encryption key are managed in a PC 52 and access to the PC 52 from another biometric authentication device as appropriate is allowed, as shown in FIG. 3. That is, among the biometric authentication system 10 shown in FIG. 2, the function of the PC 12, the function of the template management system 26, and the function of the template registration terminal 28 can be consolidated in the PC 52. This configuration allows a user to receive biometric authentication service by, for example, the photocopier 16, the entry/exit management device 18, the vending machine 20, or the like, by using the encrypted template managed by the PC 52 which is a personal property of the user.

As described, the system configuration can be modified as appropriate as long as it is within the technical idea of the present embodiment. For example, a mobile phone, a mobile information terminal, or the like, provided with the functions of the PC12 and the secure device 14 can also be used instead of the PC 12. In the following, a management method for the template encryption key according to the present embodiment will be described in detail. Additionally, for the sake of explanation, the explanation will be made with the system configuration of the biometric authentication system 10 shown in FIG. 2 in mind.

### 2: Configuration of Secure Device

Here, the configuration of the secure device 14 will be described. As described above, the present embodiment has its characteristic in the method of controlling access to the template encryption key stored in the secure device 14 by using mutual authentication between the PC 12 and the secure device 14. Thus, the configuration of the template encryption key that is stored in the secure device 14 and the configuration of access authentication key information to be used for the control of access to the template encryption key will be described in detail.

### 2-1: Data Structure within Non-Volatile Memory

First, the configuration of the template encryption key that is stored in the secure device 14 and the configuration of an access authentication key to be used for the control of access to the template encryption key will be described with reference to FIGS. 4 and 5. The management method for the template encryption key according to the present embodiment will also be described here. FIG. 4 is an explanatory diagram showing a configuration example of the template encryption key that is stored in the secure device 14. FIG. 5 is an explanatory diagram showing the data structure of service data that is stored in the secure device 14. Additionally, the service data will be described later.

First, reference will be made to FIG. 4. As shown in FIG. 4, the template encryption keys that are set for respective services are stored in the secure device 14. In the case use of multiple services is assumed as in the present embodiment, a plurality of template encryption keys will be stored in the secure device 14. For example, a system service (service 1), an entry/exit management service (service 2), . . . , a Web service (service N), etc., are stored in the non-volatile memory of the secure device 14. Additionally, the non-volatile memory in which the template encryption key is stored is tamper resistant. Also, the system service is a special service that is set in advance at the time of shipping. On the other hand, the entry/exit management service, . . . , the Web service are general services that the user registers in the secure device 14 as appropriate.

Next, reference will be made to FIG. 5. FIG. 5 shows the data structure of service data that is stored in the non-volatile memory of the secure device 14. Additionally, the service data is data formed from a service code (sc) for identifying each service, the access authentication key information (Iₐᵤₜₕ^{sc}) for controlling access to the template encryption key, template encryption key information (Iₜₑₘₚ^{sc}) including the template encryption key, and a compound permission flag (f_{comp}^{sc}). Furthermore, these pieces of data are managed, being linked to each other.

The service code (sc) is a code for identifying the difference between services and the difference between the versions. The service code is formed from a service ID (sc_{id}) and version information (scᵥₑᵣ). The service ID is identification information for identifying a service. The version information is information for identifying a version. The access authentication key information (Iₐᵤₜₕ^{sc}) is data for authentication used for mutual authentication which is for accessing the template encryption key corresponding to each service. The access authentication key information is formed from an encryption scheme (tₐᵤₜₕ^{sc}) and a service authentication key (Kₐᵤₜₕ^{sc}).

The template encryption key information (Iₜₑₘₚ^{sc}) is encryption key data for decrypting the encrypted template created for each service. The template encryption key information is formed from an encryption scheme (tₜₑₘₚ^{sc}) and a template encryption key (Kₜₑₘₚ^{sc}). The compound permission flag (f_{comp}^{sc}) is permission information indicating whether or not access authentication may be performed simultaneously with other access authentication for the template encryption keys corresponding to other services. In the case the compound permission flag is set to valid, access authentication for the template encryption keys corresponding to other services can be together established by a single mutual authentication.

As described above, the service data set for each service is stored in the secure device 14. Also, a tampering detection code is added to each piece of service data. By adding the tampering detection code, in the case the service data is corrupted for some reason, the corruption can be detected. Additionally, the service data of the system service and the service data of a general service basically have the same data structure. However, there is a difference that, in the case of the system service, restriction is placed on the service code and the compound permission flag, for example. Also, the intended use of the service code of the system service and the intended use of the service code of a general service are different. These differences will be described later.

### 3: Service Registration

As described above, the service data is stored in the secure device 14. The service data of the system service is stored in the non-volatile memory in advance at the time of shipping, or the like, of the secure device 14. On the other hand, the service data of a general service has to be registered by using the PC 12 (service registration terminal). A service registration method for storing the service data of a general service in the non-volatile memory of the secure device 14 will be described here.

### 3-1: Functional Configuration of PC (Service Registration Function Part)

First, the structural elements for providing a service registration function, in the functional configuration of the PC 12, will be described with reference to FIG. 6. FIG. 6 is an explanatory diagram showing an example of the functional configuration of the PC 12.

As shown in FIG. 6, the PC 12 includes, as main structural elements for providing the service registration function, a communication unit 102 for secure device, a system service degenerate key acquisition unit 104, a communication unit 106 for network, a system service state control unit 108, and a package service data transfer unit 110. Additionally, the communication unit 102 for secure device and the package service data transfer unit 110 are examples of a package data providing unit. Also, the communication unit 102 for secure device, the system service degenerate key acquisition unit 104, and the system service state control unit 108 are examples of a system mutual authentication unit.

The communication unit 102 for secure device is means for communicating with the secure device 14. The system service degenerate key acquisition unit 104 is means for acquiring, from the service data management system 24, a system service authentication degenerate key to be used for the mutual authentication that is performed with the secure device 14 at the time of registration of the service data of a general service The system service authentication degenerate key is generated based on a service authentication key included in the service data of the system service (hereinafter, the service authentication key and the service data are respectively referred to as “system service authentication key” and “system service data”).

Here, the system service authentication degenerate key is generated by a service management authority (the service data management system 24) managing a service providing authority or by the secure device 14 that was granted a permission by the service management authority. For example, the system service authentication degenerate key (K_{dege}^{scsys}) corresponding to the service ID (sc^{sys}) of the system service is generated by the formula (1) shown below based on the system service authentication key (Kₐᵤₜₕ^{scsys}) and a system service authentication degenerate key function d₀. The system service authentication degenerate key function d₀ is provided after permission is granted by the service management authority.

[Equation 1]

K_{dege}^{scsys}=d₀ (Kₐᵤₜₕ^{scsys}) (1)

The system service authentication degenerate key described above is acquired by the system service degenerate key acquisition unit 104 via the communication unit 106 for network. The communication unit 106 for network is means for transmitting/receiving data to/from the service data management system 24, the template management system 26 and other biometric authentication devices that are connected to the network 30. The system service authentication degenerate key acquired by the system service degenerate key acquisition unit 104 is input to the system service state control unit 108. The system service state control unit 108 is means for communicating with the secure device 14 via the communication unit 102 for secure device and for performing mutual authentication and session establishment.

When the system service authentication degenerate key is input, the system service state control unit 108 attempts mutual authentication with the secure device 14 via the communication unit 102 for secure device. When the mutual authentication succeeds, the system service state control unit 108 establishes a session, and inputs notification information indicating the success of mutual authentication (hereinafter, authentication complete notification) to the package service date transfer unit 110. Such a state where the mutual authentication by the system service authentication degenerate key has succeeded and the session is established will be referred to as a state where the system service is activated.

Information of a service the registration of which is desired by the user is input to the package service data transfer unit 110. When the authentication complete notification is input, the package service data transfer unit 110 accesses the service data management system 24 via the communication unit 106 for network, and acquires the service data of the service desired by the user. Here, the service data to be acquired by the package service data transfer unit 110 is packaged in such a format that decryption is possible only at the secure device 14. This packaging process is performed only by the service management authority or by an entity that is granted permission by the service management authority. Here, it is assumed that the service management authority (service data management system 24) performs the process.

Additionally, the packaging process is performed based on a service packaging function p₁. For example, the service code of a general service the registration of which is desired by the user is taken as sc. Also, when taking the access authentication key information corresponding to the service code sc as Iₐᵤₜₕ^{sc}, the template encryption key information as Iₜₑₘₚ^{sc}, and the compound permission flag as f_{comp}^{sc}, packaged service data (hereinafter, service package data) P_{sc} is obtained as the formulae (2) and (3) below.

[Equation 2]

S_{sc}=[sc, Iₐᵤₜₕ^{sc}, Iₜₑₘₚ^{sc}, f_{comp}^{sc}] (2)

P_{sc}=p₁ (S_{sc}) (3)

The service package data described above is acquired from the service data management system 24 by the package service data transfer unit 110, and is provided to the secure device 14 via the communication unit 102 for secure device.

As described, the PC 12 performs mutual authentication with the secure device 14 by using the system service authentication degenerate key and establishes a session, and provides the service package data to the secure device 14. At this time, since the service data is packaged in a format that the PC 12 is not capable of decrypting, the contents of the service data will not be known to the PC 12. Accordingly, the contents of the service data can be prevented from being leaked through the PC 12 at the time of registration of the service data. Also, with the mutual authentication performed between the PC 12 and the secure device 14, storage of unauthorized service data in a valid data storage location by a malicious third party can be prevented.

### 3-2: Functional Configuration of Secure Device (Service Registration Function Part)

Next, the structural elements for providing the service registration function, in the functional configuration of the secure device 14, will be described with reference to FIG. 7. FIG. 7 is an explanatory diagram showing an example of the functional configuration of the secure device 14.

As shown in FIG. 7, the secure device 14 includes, as main structural elements for providing the service registration function, a communication unit 202, a non-volatile memory 204, a system service degenerate key generation unit 206, a system service state control unit 208, and a service package data decryption unit 210. Additionally, the communication unit 202 is an example of a receiving unit. Also, the service package data decryption unit 210 is an example of a key information storage unit. Also, the system service degenerate key generation unit 206 and the system service state control unit 208 are examples of a system mutual authentication unit. Also, the system service degenerate key generation unit 206 is an example of a system degenerate key generation unit.

The communication unit 202 is means for communicating with the PC 12. The non-volatile memory 204 is storage means having tamper resistance. Furthermore, the system service data is stored in the non-volatile memory 204 in advance. When the registration process of a general service is started, the system service degenerate key generation unit 206 acquires the system service authentication key included in the system service data from the non-volatile memory 204. Then, the system service degenerate key generation unit 206 generates the system service authentication degenerate key from the system service authentication key. The system service authentication degenerate key is generated based on the formula (1) described above. Here, it is assumed that the system service authentication degenerate key function d₀ is already provided by the service management authority.

The system service authentication degenerate key generated by the system service degenerate key generation unit 206 is input to the system service state control unit 208. The system service state control unit 208 is means for performing mutual authentication with the PC 12 at the time of registration of a general service and for establishing a session. When the system service authentication degenerate key is input, the system service state control unit 208 performs mutual authentication with the PC 12 by using the system service authentication degenerate key that is input, and, in the case authentication has succeeded, establishes a session via the communication unit 202. When the system service is activated in this manner, the package service data is provided from the PC 12.

The secure device 14 acquires, by using the communication unit 202, the package service data provided by the PC 12. The package service data acquired by the communication unit 202 is input to the service package data decryption unit 210. The service package data decryption unit 210 decrypts the original service data from the package service data that has been input. Then, the service package data decryption unit 210 stores the service data that has been decrypted in the non-volatile memory 204. The service data of a general service is stored in the non-volatile memory 204 in this manner, and the data structure as shown in FIG. 5 is constructed.

In this manner, the secure device 14 performs mutual authentication with the PC 12 by using the system service authentication degenerate key, establishes a session, and acquires the service package data from the PC 12. At this time, since the service data is packaged in a format that the PC 12 is not capable of decrypting, the contents of the service data will not be known to the PC 12. Accordingly, the contents of the service data can be prevented from being leaked through the PC 12 at the time of registration of the service data. Also, with the mutual authentication performed between the PC 12 and the secure device 14, storage of unauthorized service data in a valid data storage location by a malicious third party can be prevented.

### 3-3: Functional Configuration of Service Data Management System (Service Registration Function Part)

Next, the structural elements for providing the service registration function, in the functional configuration of the service data management system 24, will be described with reference to FIG. 8. FIG. 8 is an explanatory diagram showing an example of the functional configuration of the service data management system 24.

As shown in FIG. 8, the service data management system 24 includes, as the main structural elements for providing the service registration function, a communication unit 302, a storage unit 304, a template encryption key management unit 306, a package service data generation unit 308, and a system service degenerate key generation unit 310. The service data of the system service and of a general service are stored in the storage unit 304. Additionally, the template encryption key management unit 306 is means for managing the template encryption key that provides the template encryption key at the time of encryption of a template at the template management system 26 or that inputs as appropriate the template encryption key to the package service data generation unit 308.

When the registration process of a general service is started, the system service degenerate key generation unit 310 acquires the system service authentication key from the system service data stored in the storage unit 304, and generates the system service authentication degenerate key based on the formula (1) described above. Then, the system service authentication degenerate key generated by the system service degenerate key generation unit 310 is provided to the PC 12 via the communication unit 302. Also, when information on a service desired by a user is provided by the PC 12, the package service data generation unit 308 acquires the corresponding service data from the pieces of service data stored in the storage unit 304. Then, the package service data generation unit 308 packages the acquired service data based on the formulae (2) and (3) described above, and generates package service data. Then, the package service data generated by the package service data generation unit 308 is provided to the PC 12 via the communication unit 302.

As described, the service data is provided being packaged in a format that the PC 12 is not capable of decrypting. Accordingly, the contents of the service data will not be known to the PC 12 at the time of registration of a general service. As a result, the contents of the service data can be prevented from leaking through the PC 12 at the time of registration of the service data.

### 3-4: Flow of Service Registration Process

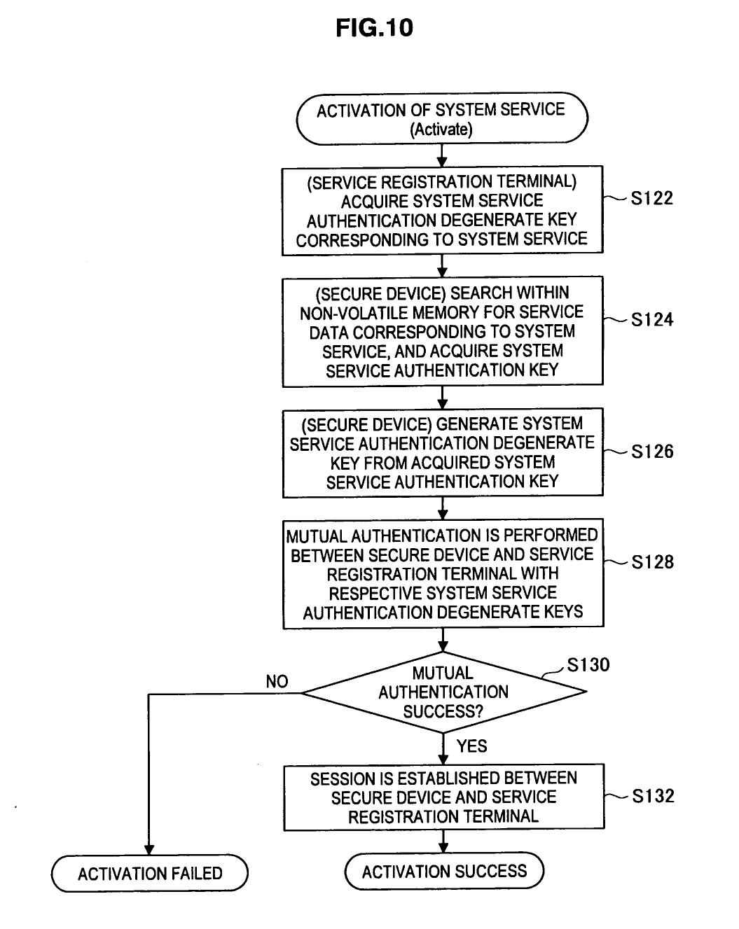

Next, the flow of a service registration process of the biometric authentication system 10 will be described with reference to FIGS. 9 and 10. FIG. 9 is an explanatory diagram showing an overall flow of the service registration process of the biometric authentication system 10. FIG. 10 is an explanatory diagram showing in detail the flow of a system service activation process in the service registration process of the biometric authentication system 10. Additionally, in FIGS. 9 and 10, the PC 12 is expressed as a service registration terminal.

### 3-4-1: Overall Process Flow

First, the overall flow of the service registration process will be described with reference to FIG. 9. As shown in FIG. 9, a user starts a registration process of a general service, and selects a desired service on the PC 12 (S102). However, it is also possible that a specific service is automatically selected by the PC 12 (S102). When the service to be registered (hereinafter, a selected service) is selected, the PC 12 acquires the service package data corresponding to the selected service (S104). Then, the PC 12 and the secure device 14 perform an activation process of the system service (S106). The activation process of the system service will be described later.

Next, whether the activation process of the system service has succeeded or not is decided (S108). In the case the activation of the system service has succeeded, the PC 12 assesses the validity of the package service data based on the tampering detection code added to the package service data (S110), and decides the validity of the package service data (S112). In the case the package data is valid, the PC 12 proceeds to the process of step S114. On the other hand, in the case the package data is data that has been tampered, the PC 12 outputs an error and ends the series of processes relating to the registration of the service. In the case of proceeding to the process of step S114, the PC 12 inputs the service package data to the secure device 14 (S114).

Then, the secure device 14 decrypts the original service data from the service package data input by the PC 12 (S116). Then, the secure device 14 stores the service data that has been decrypted in the non-volatile memory 204 (S118). Then, the PC 12 and the secure device 14 inactivate the system service (S120), and end the series of processes relating to the registration of the service. Additionally, a state where the session between the PC 12 and the secure device 14 is established is maintained until the inactivation of the system service, and thus it is possible to select another general service and to successively register the same in the secure device 14.

### 3-4-2: Flow of System Service Activation Process

Here, a flow of an activation process of the system service will be described with reference to FIG. 10. FIG. 10 is an explanatory diagram showing a flow of the activation process of the system service.

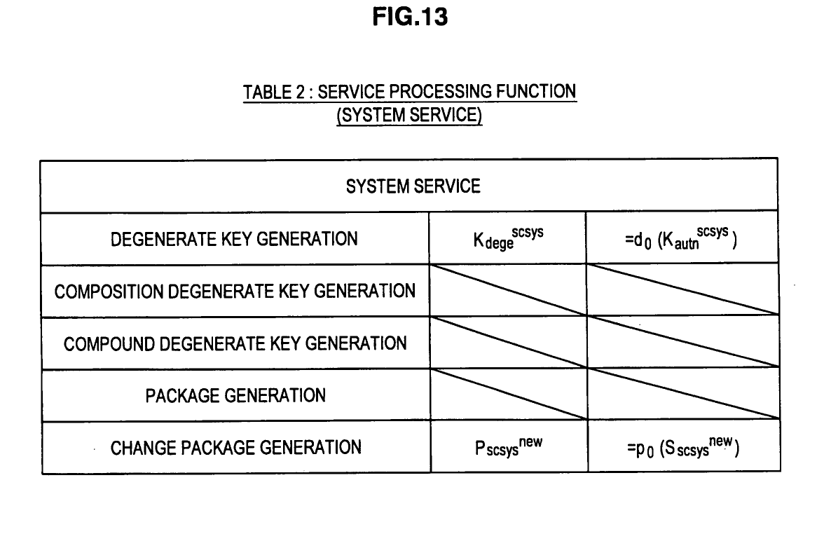

As shown in FIG. 10, when the activation process of the system service is started, the PC 12 acquires the system service authentication degenerate key corresponding to the system service (S122). Then, the secure device 14 searches through the non-volatile memory 204 for the service data corresponding to the system service, and acquires the system service authentication key (S124). Then, the secure device 14 generates a system service authentication degenerate key based on the formula (1) described above from the acquired system service authentication key (S126; refer to FIG. 13).

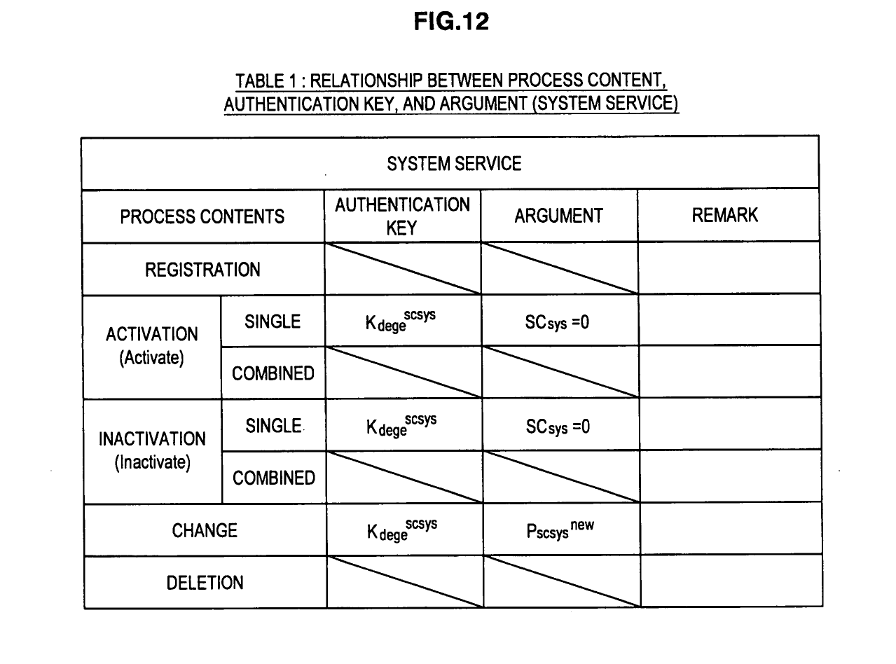

Then, the PC 12 and the secure device 14 perform mutual authentication (S128, 5130) by using the system service authentication degenerate key (refer to FIG. 12) that each has prepared. In the case the mutual authentication succeeds, they proceed to the process of step S132, and a session is established between the PC 12 and the secure device 14 (S132), and the system service is activated. On the other hand, in the case the mutual authentication fails, an error is output and the series of processes relating to the activation of the system service is ended. The activation process of the system service is performed in this manner.

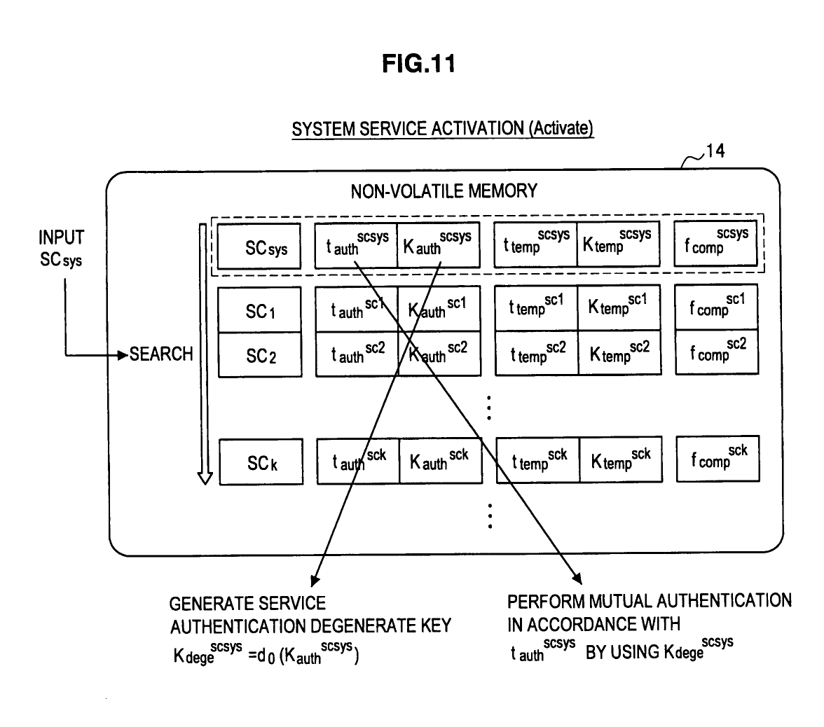

The activation process of the system service shown in FIG. 10 can be summarized in a simple schematic diagram shown in FIG. 11. FIG. 11 is an explanatory diagram schematically showing the contents of the service data stored in the non-volatile memory 204 of the secure device 14. As shown in FIG. 11, a plurality of pieces of service data including the system service data are stored in the non-volatile memory 204. When the activation process of the system service is started, the secure device 14 searches for the system service data with the service code sc_{sys} of the system service as a search key. When the service data of the service code sc_{sys} is detected, the secure device 14 extracts the access authentication key information Iₐᵤₜₕ^{scsys} included in the service data.

The system service authentication key Kₐᵤₜₕ^{scsys} and the encryption scheme tₐᵤₜₕ^{scsys} are included in the access authentication key information Iₐᵤₜₕ^{scsys}. The secure device 14 first generates the system service authentication degenerate key K_{dege}^{scsys} by using the system service authentication key Kₐᵤₜₕ^{scsys}. The generation method of the system service authentication degenerate key K_{dege}^{scsys} is as shown in the formula (1) described above. When the system service authentication degenerate key K_{dege}^{scsys} is generated, the secure device 14 performs mutual authentication with the PC 12 by using the generated system service authentication degenerate key K_{dege}^{scsys} and in accordance with the encryption scheme tₐᵤₜₕ^{scsys}. Then, when the mutual authentication is established, a session can be established (the system service can be activated) between the PC 12 and the secure device 14.

When the system service is activated in this manner, it becomes possible to register a general service in the secure device 14 by performing the service registration process shown in FIG. 9. Furthermore, when the registration process of a general service is complete, the system service is inactivated, and the session between the PC 12 and the secure device 14 is cancelled. While the system service is in an activated state, two or more general services can be registered. On the other hand, when the system service is inactivated, it is not possible to register the general service, and the activation process of the system service shown in FIG. 10 has to be performed again at the time of registering the general service.

### (Supplementary Description)

The description of the system service will be supplemented here. As has been described, the system service is a special service that is registered in advance at the time of shipping of the secure device 14. As described above, the system service is activated at the time of registration of a general service, and plays a role of preventing unauthorized data to be written in the non-volatile memory 204 of the secure device 14 by an unauthorized service registration terminal or preventing the contents of the non-volatile memory 204 to be inadvertently read. Accordingly, there is no process of registration of the system service to be performed by the user (refer to FIG. 12).

Furthermore, the service ID of the system service is fixed to a specific value (for example, 0). Also, a plurality of pieces of service data of different versions will not be stored in the non-volatile memory 204. Furthermore, it is not possible to delete the system service (refer to FIG. 12). However, the system service may be changed (update of version). However, a plurality of system services are not to be present in the non-volatile memory 204, and thus the system service before the change will be erased. The method of changing the system service has much in common with the method of changing a general service, and thus detailed description thereof will be made at the time of describing the method of changing a general service.

Heretofore, the service registration method of the biometric authentication system 10 has been described. As described above, with the biometric authentication system 10, activation of the system service becomes necessary at the time of registration of a general service. Thus, registration of unauthorized data in the secure device 14 by a malicious third party can be prevented. Also, at the time of providing the service data of a general service to the secure device 14, the service data is packaged in a format that the service registration terminal and the biometric authentication device are not capable of decrypting. Thus, the contents of the service data can be prevented from being leaked to other service providers and to a malicious third party.

### 4: Service Activation

Next, an activation process of a general service will be described. As described above, the activation process of the system service is performed at the time of registration of a general service. On the other hand, the activation process of a general service is performed to place the general service in a usable state. That is, the activation process of a general service to be described in the following is performed at the time of, for example, activating a biometric authentication service that is performed at the time of receiving a general service. However, it should be noted that the activation process of a general service is performed also at the time of changing or deleting the general service. This will be described later.

### 4-1: Functional Configuration of PC (Service Activation Function Part)

First, the structural elements for providing a service activation function, in the functional configuration of the PC 12, will be described with reference to FIG. 6. FIG. 6 is an explanatory diagram showing an example of the functional configuration of the PC 12.

As shown in FIG. 6, the PC 12 includes, as main structural elements for providing the service activation function, communication unit 102 for secure device, the communication unit 106 for network, a general service degenerate key acquisition unit 112, and a general service state control unit 114. Additionally, the communication unit 102 for secure device, the general service degenerate key acquisition unit 112, and the general service state control unit 114 are examples of a mutual authentication unit.

The general service degenerate key acquisition unit 112 is means for acquiring, from the service data management system 24, a general service authentication degenerate key that is used for mutual authentication to be performed with the secure device 14 at the time of activating a general service. The general service authentication degenerate key is generated based on a service authentication key included in service data of the general service (hereinafter, the service authentication key and the service data are respectively referred to as “general service authentication key” and “general service data”).

Here, the general service authentication degenerate key is generated by a service management authority (the service data management system 24) managing a service providing authority or by the secure device 14 that was granted a permission by the service management authority. For example, the general service authentication degenerate key. (K_{dege}^{sc}) corresponding to the service ID (sc) of the general service is generated by the formula (4) shown below based on the general service authentication key (Kₐᵤₜₕ^{sc}) and a general service authentication degenerate key function d₁. The general service authentication degenerate key function d₁ is provided after permission is granted by the service management authority.

[Equation 3]

K_{dege}^{sc}=d₁ (Kₐᵤₜₕ^{sc}) (4)

The general service authentication degenerate key described above is acquired by the general service degenerate key acquisition unit 112 via the communication unit 106 for network. The general service authentication degenerate key acquired by the general service degenerate key acquisition unit 112 is input to the general service state control unit 114. The general service state control unit 114 is means for communicating with the secure device 14 via the communication unit 102 for secure device and for performing mutual authentication and session establishment.

When the general service authentication degenerate key is input, the general service state control unit 114 attempts mutual authentication with the secure device 14 via the communication unit 102 for secure device. When the mutual authentication succeeds, the general service state control unit 114 establishes a session, and inputs notification information indicating the success of mutual authentication (hereinafter, authentication complete notification) to an encrypted template acquisition unit 116. Such a state where the mutual authentication by the general service authentication degenerate key has succeeded and the session is established will be referred to as a state where the general service is activated.

Furthermore, when the general service is activated, the general service state control unit 114 acquires a template encryption key corresponding to the general service from the secure device 14. Then, the template encryption key acquired by the general service state control unit 114 is input to a template decryption unit 118. This template encryption key is used and the biometric authentication service is provided at the time of use of the general service. However, the authentication complete notification is not input to the encrypted template acquisition unit 116, nor the template encryption key is acquired in the activation process of a general service that is performed at the time of a general service change process or a general service deletion process.

The PC 12 performs mutual authentication with the secure device 14 by using the general service authentication degenerate key and establishes a session in such a manner, and acquires the template encryption key or accesses the non-volatile memory 204 of the secure device 14. With the mutual authentication performed between the PC 12 and the secure device 14 in such a manner, unauthorized acquisition of the template encryption key or an unauthorized access to the non-volatile memory 204 by a malicious third party can be prevented.

### 4-2: Functional Configuration of Secure Device (Service Activation Function Part)

Next, the structural elements for providing the service activation function, in the functional configuration of the secure device 14, will be described with reference to FIG. 7. FIG. 7 is an explanatory diagram showing an example of the functional configuration of the secure device 14.

As shown in FIG. 7, the secure device 14 includes, as main structural elements for providing the service activation function, the communication unit 202, the non-volatile memory 204, a general service degenerate key generation unit 212, and a general service state control unit 214. Additionally, the general service degenerate key generation unit 212 and the general service state control unit 214 are examples of a mutual authentication unit. Also, the general service degenerate key generation unit 212 is an example of a degenerate key generation unit. Additionally, the general service data is assumed to be stored in the non-volatile memory 204.

When the activation process of a general service is started, a service code of a general service that is to be activated is input to the secure device 14 from the PC 12. This service code is input to the general service degenerate key generation unit 212 via the communication unit 202. The general service degenerate key generation unit 212 acquires the general service authentication key included in the general service data from the non-volatile memory 204 based on the input service code. Then, the general service degenerate key generation unit 212 generates the general service authentication degenerate key from the general service authentication key. The general service authentication degenerate key is generated based on the formula (4) mentioned above. It is assumed here that the general service authentication degenerate key function d₁ is already provided by the service management authority.

The general service authentication degenerate key generated by the general service degenerate key generation unit 212 is input the general service state control unit 214. The general service state control unit 214 is means for performing mutual authentication with the PC 12 to activate a general service, and for establishing a session. When the general service authentication degenerate key is input, the general service state control unit 214 performs mutual authentication with the PC 12 by using the input general service authentication degenerate key, and in case the authentication succeeds, establishes a session via the communication unit 202.

In the case of an activation process that is performed at the time of use of a general service, the general service state control unit 214 acquires the template encryption key from the non-volatile memory 204, and stores the same in a volatile memory 216 that can be read by the PC 12. Then, in the case an acquisition request for the template encryption key is received from the PC 12, the template encryption key stored in the volatile memory 216 is read out and is provided to the PC 12 via the communication unit 202. On the other hand, in the case of an activation process that is performed at the time of change or deletion of a general service, the general service state control unit 214 does not perform the process of storing the template encryption key in the volatile memory 216.

In this manner, the secure device 14 performs mutual authentication with the PC 12 by using the general service authentication degenerate key and establishes a session, and then provides the template encryption key or accepts access to the non-volatile memory 204. With the mutual authentication between the PC 12 and the secure device 14 performed in this manner, unauthorized acquisition of the template encryption key or unauthorized access to the non-volatile memory 204 by a malicious third party can be prevented.

### 4-3: Functional Configuration of Service Data Management System (Service Activation Function Part)

Next, the structural elements for providing the service activation function, in the functional configuration of the service data management system 24, will be described with reference to FIG. 8. FIG. 8 is an explanatory diagram showing an example of the functional configuration of the service data management system 24.

As shown in FIG. 8, the service data management system 24 includes, as the main structural elements for providing the service activation function, a communication unit 302, a storage unit 304, and a general service degenerate key generation unit 312. The service data of the system service and of a general service are stored in the storage unit 304.

When the activation process of a general service is started, the service code of the general service is input from the PC 12. This service code is input to the general service degenerate key generation unit 312 via the communication unit 302. The general service degenerate key generation unit 312 acquires a general service authentication key from the general service data stored in the storage unit 304 based on the input service code, and generates a general service authentication degenerate key based on the formula (4) mentioned above. Then, the general service authentication degenerate key generated by the general service degenerate key generation unit 312 is provided to the PC 12 via the communication unit 302.

### 4-4: Flow of Service Activation Process

Next, a flow of the activation process of a general service will be described with reference to FIG. 14. FIG. 14 is an explanatory diagram showing a flow of the activation process of a general service. Additionally, in FIG. 14, the PC 12 is referred to as a service registration terminal.

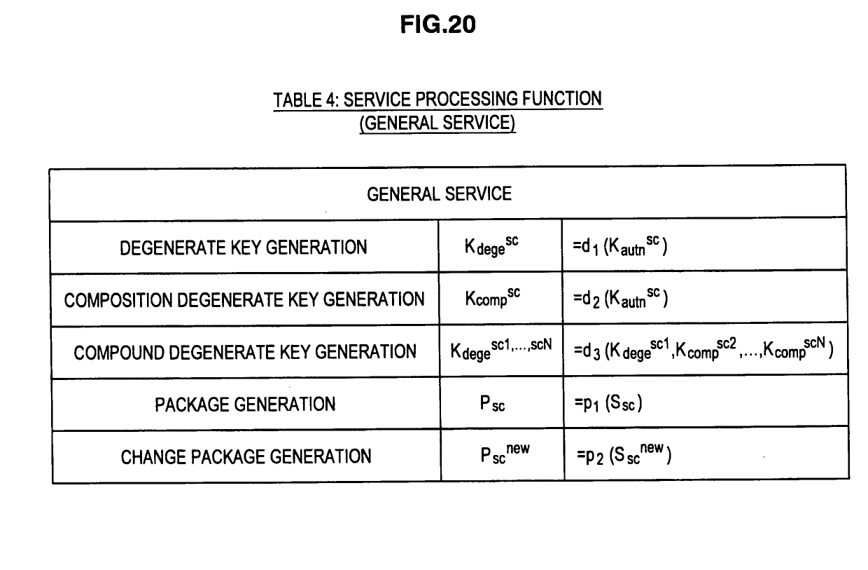

As shown in FIG. 14, when the activation process of a general service is started, a desired service is selected, and the PC 12 acquires the general service authentication degenerate key corresponding to the selected general service (S142). Then, the PC 12 provides the secure device 14 with the service code of the selected service (S144). Then, the secure device 14 searches through the non-volatile memory 204 for the service data of the general service corresponding to the provided service code, and acquires the general service authentication key (S146). Then, the secure device 14 generates a general service authentication degenerate key from the acquired general service authentication key based on the formula (4) mentioned above (S148; refer to FIG. 20).

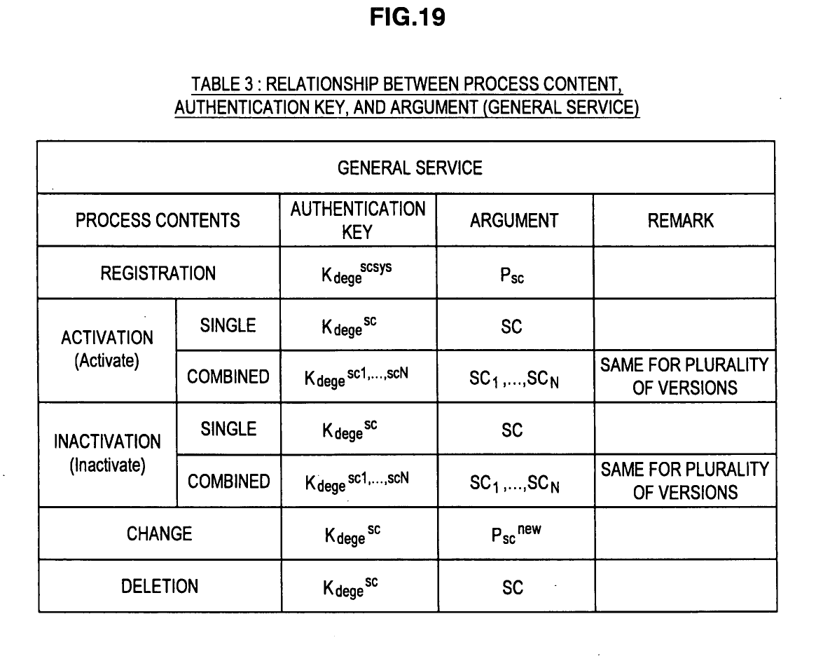

Next, the PC 12 and the secure device 14 perform mutual authentication (S150, S152) by using the general service authentication degenerate key (refer to FIG. 19) that each has prepared. In the case the mutual authentication succeeds, they proceed to the process of step S154, and a session is established between the PC 12 and the secure device 14 (S154), and the general service is activated. On the other hand, in the case the mutual authentication fails, an error is output and the series of processes relating to the activation of the general service is ended. The activation process of the general service is performed in this manner.

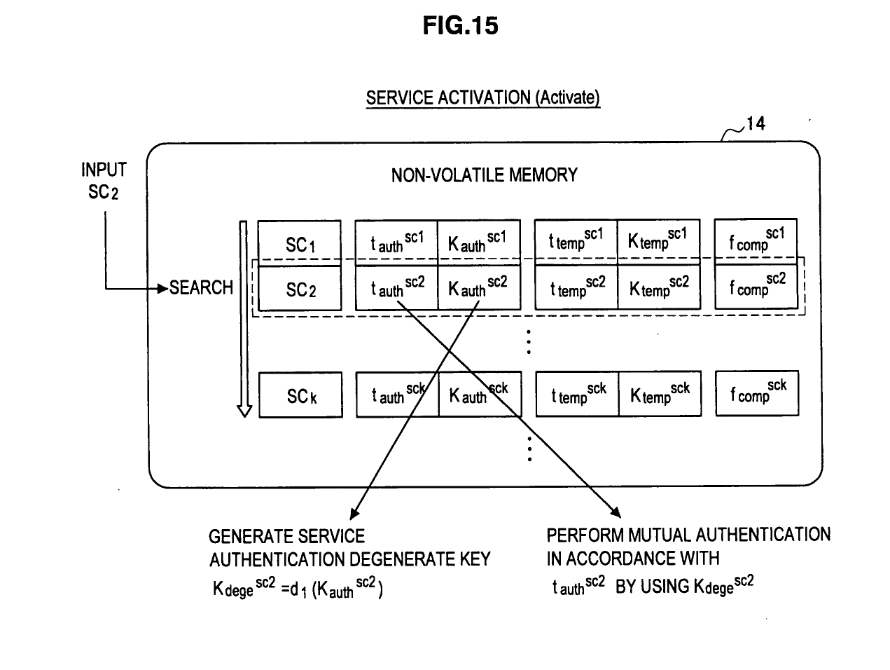

The activation process of a general service shown in FIG. 14 can be summarized in a simple schematic diagram shown in FIG. 15. FIG. 15 is an explanatory diagram schematically showing the contents of the service data stored in the non-volatile memory 204 of the secure device 14. As shown in FIG. 15, a plurality of pieces of service data including the system service data are stored in the non-volatile memory 204. When the activation process of a general service is started, the secure device 14 searches for the general service data with a service code that is input, for example, sc₂, as a search key. When the service data of the service code sc₂ is detected, the secure device 14 extracts access authentication key information Iₐᵤₜₕ^{sc2} included in the service data.

A general service authentication key Kₐᵤₜₕ^{sc2} and an encryption scheme tₐᵤₜₕ^{sc2} are included in the access authentication key information Iₐᵤₜₕ^{sc2}. The secure device 14 first generates a general service authentication degenerate key K_{dege}^{sc2} by using the general service authentication key Kₐᵤₜₕ^{sc2}. The generation method of the general service authentication degenerate key K_{dege}^{sc2} is as shown in the formula (4) mentioned above. When the general service authentication degenerate key K_{dege}^{sc2} is generated, the secure device 14 performs mutual authentication with the PC 12 by using the generated general service authentication degenerate key K_{dege}^{sc2} and in accordance with the encryption scheme tₐᵤₜₕ^{sc2}. Then, when the mutual authentication is established, a session can be established (the general service can be activated) between the PC 12 and the secure device 14.

As such, a general service can be activated by the methods shown in FIGS. 14 and 15. Here, according to the activation process shown in FIGS. 14 and 15, one service is activated by one process. However, when making a large number of services available, it would be too tedious to perform the process shown in FIGS. 14 and 15 for each of the services. Thus, a method of simultaneously activating a plurality of services is desired. There is also a desire to simultaneously activate services in the case a plurality of services of different versions exist. Thus, an explanation will be also given on a method of simultaneously activating a plurality of services (hereinafter, combined activation).

### 4-5: Simultaneous Activation of a Plurality of Services

A method of simultaneously activating a plurality of services will be described here. Additionally, at the time of the combined activation, the generation method of the general service authentication degenerate key is changed. Thus, the functions of the general service degenerate key generation unit 212 of the secure device 14 and the general service degenerate key generation unit 312 of the service data management system 24 are changed. First, the details of the change will be described.

The general service authentication degenerate key relating to a single service was obtained by inputting a general service authentication key to the general service authentication degenerate key function d₁ based on the formula (4) mentioned above. However, in the case of simultaneously activating a plurality of services, a degenerate key function d₂ for service composition and a compound service authentication degenerate key function d₃ shown in the following formulae (5) and (6) are used (refer to FIG. 20). Also, a compound service authentication degenerate key that is obtained by the following formula (6) is used for the mutual authentication that is performed between the PC 12 and the secure device 14.

For example, a method of generating a compound service authentication degenerate key K_{dege}^{sc1, sc2} from general service authentication keys Kₐᵤₜₕ^{sc1} and Kₐᵤₜₕ^{sc2} corresponding to service codes sc₁ and sc₂ will be considered. Here, it is assumed that there is a primary-secondary relationship between the services corresponding to the service codes sc₁ and sc₂, and that the service of the service code sc₁ is primary and the service of the service code sc₂ is secondary.

First, the general service authentication key Kₐᵤₜₕ^{sc1} corresponding to the primary service is input to the service authentication degenerate key function d₁, and the service authentication degenerate key K_{dege}^{sc1} is generated as shown in the formula (4) mentioned above. Then, the general service authentication key Kₐᵤₜₕ^{sc2} corresponding to the secondary service is input to the degenerate key function d₂ for service composition, and a degenerate key K_{comp}^{sc2} for service composition is generated as shown in the following formula (5). Then, the service authentication degenerate key K_{dege}^{sc1} corresponding to the primary service and the degenerate key K_{comp}^{sc2} for service composition corresponding to the secondary service are input to the compound service authentication degenerate key function d₃, and the compound service authentication degenerate key K_{dege}^{sc1, sc2} is generated as shown in the following formula (6).

[Equation 4]

K_{comp}^{sc2}=d₂ (Kₐᵤₜₕ^{sc2}) (5)

K_{dege}^{sc1, sc2}=d₃ (K_{dege}^{sc1}, K_{comp}^{sc2}) (6)

Here, the degenerate key for service composition and the compound service authentication degenerate key are generated by the service management authority (the service data management system 24) managing a service providing authority or by the secure device 14 that was granted a permission by the service management authority. Additionally, the system is configured such that a provider providing the secondary service plays the role of generating the degenerate key for service composition and a provider providing the primary service plays the role of generating the compound service authentication degenerate key.

At this time, the provider of the secondary service provides the provider of the primary service with only the degenerate key for service composition, and does not provide information about the general service authentication key relating to the secondary service. This mechanism enables to generate the compound service authentication key in a state where the service providers do not know the service authentication key of each other. However, a mechanism according to which it is not possible to back calculate the original general service authentication key from the degenerate key for service composition is to be provided as a premise.

Heretofore, the generation method of the compound service authentication degenerate key that is used for the combined activation process has been described. In the case the function of the combined activation is provided, the function of generating the compound service authentication degenerate key based on the formulae (5) and (6) mentioned above is added to the general service degenerate key generation unit 212 of the secure device 14 and to the general service degenerate key generation unit 312 of the service data management system 24.

### 4-5-1: Simultaneous Activation of Different Services

Next, the flow of process at the time of performing the combined activation by using the compound service authentication degenerate key described above will be described with reference to FIG. 16. FIG. 16 is an explanatory diagram showing the flow of the combined activation process. Additionally, in FIG. 16, the PC 12 is referred to as a service registration terminal.

As shown in FIG. 16, when the combined activation process of general services is started, a plurality of services that are to be activated are selected at the PC 12 (S162). Then, the PC 12 acquires the compound service authentication degenerate key for the selected general services (S164). Then, the PC 12 provides the secure device with the service codes of the selected services (S166). Then, the secure device 14 searches within the non-volatile memory 204 for pieces of service data of the general services corresponding to the service codes that have been provided, and acquires the general service authentication keys (S168). Then, the secure device 14 generates the general service authentication degenerate key and the degenerate key for service composition from the acquired general service authentication keys based on the formulae (4) and (5) mentioned above (S170; refer to FIG. 20).

Then, the secure device 14 generates a compound service authentication degenerate key by using the general service authentication degenerate key and the degenerate key for service composition that have been generated, based on the formula (6) mentioned above (S172). Then, the PC 12 and the secure device 14 perform mutual authentication (S174, S176) by using the compound service authentication degenerate key (refer to FIG. 19) that each has prepared. In the case the mutual authentication succeeds, they proceed to the process of step S178, and a session is established between the PC 12 and the secure device 14 (S178), and the plurality of general services that were selected are simultaneously activated. On the other hand, in the case the mutual authentication fails, an error is output and the series of processes relating to the combined activation of the services is ended. The combined activation process of services is performed in this manner.

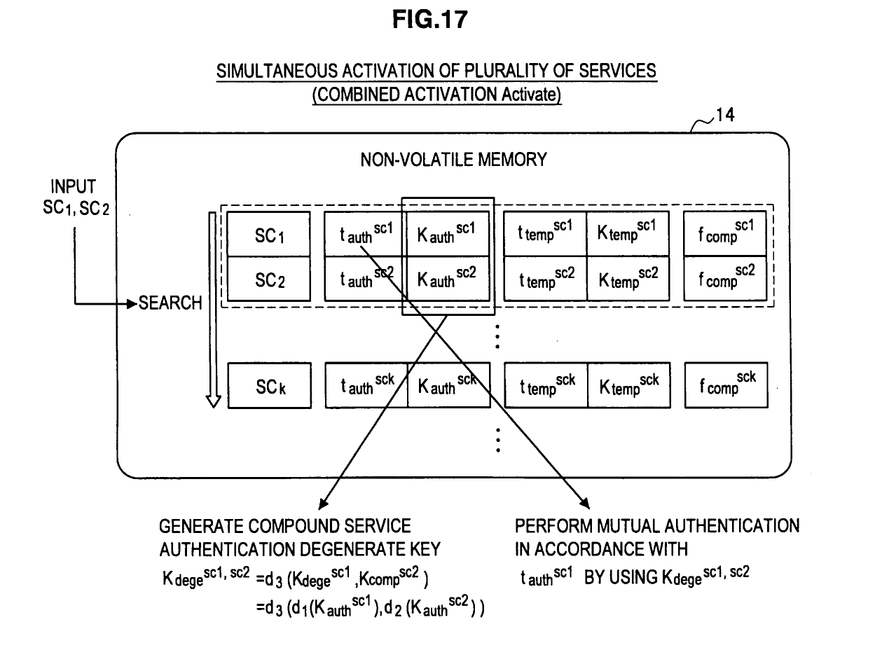

The combined activation process of services shown in FIG. 16 can be summarized in a simple schematic diagram shown in FIG. 17. FIG. 17 is an explanatory diagram schematically showing the contents of the service data stored in the non-volatile memory 204 of the secure device 14. As shown in FIG. 17, a plurality of pieces of service data including the system service data are stored in the non-volatile memory 204. When the combined activation process of services is started, the secure device 14 searches for the general service data with, for example, the service codes sc_{sc1} and sc_{sc2} that have been input as search keys.

Here, it is assumed that the service of the service code sc_{sc1} is primary and the service of the service code sc_{sc2} is secondary. When the service data of the service codes sc_{sc1} and sc_{sc2} are detected, the secure device 14 extracts access authentication key information Iₐᵤₜₕ^{sc1} and Iₐᵤₜₕ^{sc2} included in the service data. The general service authentication key Kₐᵤₜₕ^{sc1} and an encryption scheme tₐᵤₜₕ^{sc1} are included in the access authentication key information Iₐᵤₜₕ^{sc1}. The general service authentication key Kₐᵤₜₕ^{sc2} and an encryption scheme tₐᵤₜₕ^{sc2} are included in the access authentication key information Iₐᵤₜₕ^{sc2}.

First, the secure device 14 generates a general service authentication degenerate key K_{dege}^{sc1} by using the general service authentication key Kₐᵤₜₕ^{sc1}. The generation method of the general service authentication degenerate key K_{dege}^{sc1} is as shown by the formula (4) mentioned above. Next, the secure device 14 generates the degenerate key K_{comp}^{sc2} for service composition by the service using general authentication key Kₐᵤₜₕ^{sc2}. The generation method of the degenerate key K_{comp}^{sc2} for service composition is as shown in the formula (5) mentioned above. When the general service authentication degenerate key K_{dege}^{sc1} and the degenerate key K_{comp}^{sc2} for service composition are generated, the secure device 14 generates the compound service authentication degenerate key K_{dege}^{sc1, sc2} based on the formula (6) mentioned above.

Then, by using the compound service authentication degenerate key K_{dege}^{sc1, sc2} that has been generated, the secure device 14 performs mutual authentication with the PC 12 according to the encryption scheme tₐᵤₜₕ^{sc1} of the primary service. Then, when the mutual authentication is established, a session (combined activation of services) can be established between the PC 12 and the secure device 14. At this time, two general services corresponding to the service codes sc₁ and sc₂ are simultaneously activated, and thus these two general services are placed in usable state. For example, the template encryption key of the service code sc₁ and the template encryption key of the service code sc₂ are simultaneously placed in usable state. Additionally, although the combined activation method of two services is described here, combined activation of three or more services is also possible in the same manner (refer to FIGS. 19 and 20).

### 4-5-2: Simultaneous Activation of Different Versions

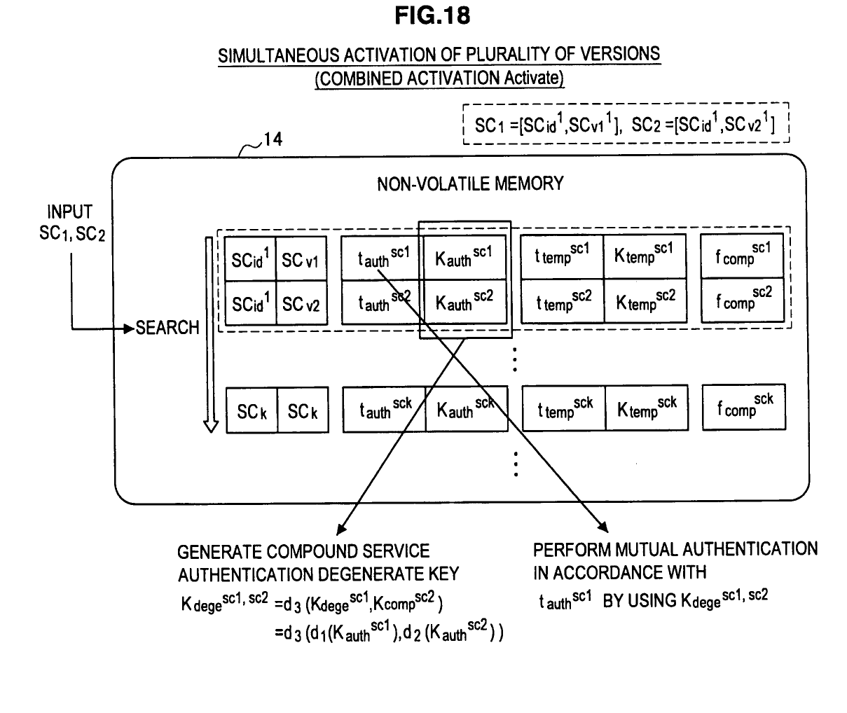

The combined activation method of simultaneously activating a plurality of services has been described. This method can also be used as a method of simultaneously activating a plurality of services that have the same service ID but that are of different versions. A simultaneous activation method for a plurality of versions will be described here with reference to FIG. 18.

As has been described above, the service code is formed from the service ID and the version information. Accordingly, there may exist pieces of service data with the same service ID but with different version information. For example, it is assumed that the service ID is id₁ and the version information is v₁ for the service code sc₁, and that the service ID is id₁ and the version information is v₂ for the service code sc₂. And a case is considered where the service codes sc₁ and sc₂ are to be simultaneously activated. In this case, since the contents of the services are the same, there is no primary-secondary relationship between the pieces of the service data. Accordingly, one is set to be primary and the other is set to secondary according to a specific rule, and the compound service authentication degenerate key is generated in the same way as the combined activation method described above.

For example, the service of the service code sc₁ (version information=v₁) is set to be primary, and the service of the service code sc₂ (version information=v₂) is set to be secondary. In this case, the general service authentication degenerate key K_{dege}^{sc1} is generated from the general service authentication key Kₐᵤₜₕ^{sc1} based on the formula (4) mentioned above, and the degenerate key K_{comp}^{sc2} for service composition is generated from the general service authentication key Kₐᵤₜₕ^{sc2} based on the formula (5) mentioned above. Then, the compound service authentication degenerate key K_{dege}^{sc1, sc2} is generated from the general service authentication key Kₐᵤₜₕ^{sc1} and the degenerate key K_{comp}^{sc2} for service composition. Then, mutual authentication is performed according to the encryption scheme tₐᵤₜₕ^{sc1} of the service code sc₁.

As described, a plurality of services with the same service ID and of different versions can be simultaneously activated. Additionally, a method of simultaneously activating two services of different versions has been described here, but it is also possible to simultaneously activate three or more services of different versions in the same manner (refer to FIGS. 19 and 20).

### 5. Biometric Authentication

Heretofore, the registration method of general service data used at the time of using a general service, and the activation method of the general service have been described. Also, the activation method of the system service and the role of the system service have been described therein. In the following, a biometric authentication service providing method that is performed in a state where the general service is activated is described.

### 5-1: Functional Configuration of PC (Biometric Authentication Function Part)

First, the structural elements relating to a biometric authentication service providing function, in the functional configuration of the PC 12, will be described with reference to FIG. 6. FIG. 6 is an explanatory diagram showing an example of the functional configuration of the PC 12.

As shown in FIG. 6, the PC 12 includes, as the main structural elements relating to the biometric authentication service providing function, the communication unit 102 for secure device, the communication unit 106 for network, the general service degenerate key acquisition unit 112, the general service state control unit 114, the encrypted template acquisition unit 116, the template decryption unit 118, a template checking unit 120, and a biometric pattern acquisition unit 122. Also, the PC 12 further includes a service providing unit 124 that is for providing a specific service in the case biometric authentication succeeds. The service providing unit 124 is for providing a Web service or the like, for example. Additionally, the biometric pattern acquisition unit 122 is an example of a biometric information acquisition unit. Also, the template checking unit 120 is an example of a biometric authentication unit.

In the biometric authentication system 10, an encrypted template is provided for each service. Accordingly, a user has to select a general service that is to be made usable by using biometric authentication. First, the PC 12 presents to the user information on the general services registered in the secure device 14 via the communication unit 102 for secure device. The user selects a desired service by referring to the information on the general services that are presented. However, if a service that can be activated by the PC 12 is fixed, the service is automatically selected. When a service is selected, the PC 12 activates the service. The activation method of a general service is as described above.

When the activation process of the general service is complete, an authentication complete notification is input to the encrypted template acquisition unit 116 from the general service state control unit 114. When the authentication complete notification is input, the encrypted template acquisition unit 116 transmits a service code to the template management system 26 connected to the network 30 via the communication unit 106 for network, and acquires the encrypted template corresponding to the service code. The encrypted template acquired by the encrypted template acquisition unit 116 is input to the template decryption unit 118.

Furthermore, a template encryption key is acquired from the secure device 14 via the communication unit 102 for secure device, and is input to the general service state control unit 114. Then, the template encryption key that is input to the general service state control unit 114 is input to the template decryption unit 118. The template decryption unit 118 decrypts the original template from the encrypted template input from the encrypted template acquisition unit 116 by using the template encryption key input from the general service state control unit 114. Then, the template that has been decrypted by the template decryption unit 118 is input to the template checking unit 120.

Furthermore, biometric pattern information of a user that is to be checked against the template is input from the biometric pattern acquisition unit 122 to the template checking unit 120. The biometric pattern acquisition unit 122 mainly includes an imaging unit and an image processing unit. The biometric pattern acquisition unit 122 generates biometric pattern information that can be compared with the template by capturing the image of a specific body part by using the imaging unit and performing a specific image process on the captured image data by using the image processing unit. For example, the vein pattern of a finger of the user is captured by the biometric pattern acquisition unit 122 and binarization and a specific conversion process are performed on the captured data, and the biometric pattern information is generated. Furthermore, a specific compression encoding process may also be performed at the image processing unit.

When the decrypted template and the biometric pattern information are input, the template checking unit 120 checks the template and the biometric pattern information against each other, and decides whether or not they match each other to a certain level or more. In the case the degree of their match is above the certain level, the template checking unit 120 decides that the biometric authentication succeeded, and inputs a biometric authentication result indicating the success of the biometric authentication to the service providing unit 124. When the biometric authentication result is input, the service providing unit 124 starts providing the service desired by the user. On the other hand, in the case the degree of their match falls below the certain level, the template checking unit 120 outputs an error, having decided that the biometric authentication failed.

As described above, in the biometric authentication system 10, the encrypted template is managed for each service. And unless a service that a user wants to use is activated, it is not possible to use the service. Also, to activate the service, mutual authentication with the secure device 14 has to be established. According to this configuration, even if the template encryption key of a certain service is exposed, other services will not be affected. Furthermore, with the template encryption key appropriately managed, it becomes needless to manage the encrypted template itself in a tamper resistant device, making it possible to store the encrypted template in the server on a network or in an electronic device possessed by an individual, for example.

### 5-2: Functional Configuration of Biometric Authentication Device

Now, the above-described PC 12 was a device that included both the function of the service registration terminal and the function of the biometric authentication device. However, not all the biometric authentication devices have to be provided with the function of the service registration terminal. For example, the photocopier 16, the entry/exit management device 18, the vending machine 20, and the like, shown in FIG. 2 may be provided with only the function of providing the biometric authentication service. In this case, the functional configuration of the biometric authentication device equipped in the photocopier 16, the entry/exit management device 18, the vending machine 20, and the like, is as shown in FIG. 21. In the following, the functional configuration of the biometric authentication device equipped in the photocopier 16, the entry/exit management device 18, the vending machine 20, and the like, will be described with reference to FIG. 21.

As shown in FIG. 21, the biometric authentication device according to the present embodiment mainly includes a communication unit 402 for secure device, a general service state control unit 404, a general service degenerate key acquisition unit 406, a communication unit 408 for network, an encrypted template acquisition unit 410, a template decryption unit 412, a template checking unit 414, a biometric pattern acquisition unit 416, and a service providing unit 418. The service providing unit 418 is for providing a photocopying service, an entry/exit management service, a vending service, and the like. Additionally, the biometric pattern acquisition unit 416 is an example of a biometric information acquisition unit. Also, the template checking unit 414 is an example of a biometric authentication unit.

When a biometric authentication service is started, the general service degenerate key acquisition unit 406 first acquires a general service authentication degenerate key from the service data management system 24 via the communication unit 408 for network. Then, the general service authentication degenerate key acquired by the general service degenerate key acquisition unit 406 is input to the general service state control unit 404. Additionally, when the number of services that can be used by the biometric authentication device is set to 1, the service code of the service is automatically transmitted from the communication unit 408 for network to the service data management system 24, and the general service authentication degenerate key corresponding to the service code is acquired. Furthermore, the service code is also input to the secure device 14 via the communication unit 402 for secure device.

When the general service authentication degenerate key is input, the general service state control unit 404 attempts mutual authentication with the secure device 14 by using the general service authentication degenerate key that has been input. When the mutual authentication fails, the general service state control unit 404 outputs an error. For example, the mutual authentication fails in case the service data of a service that the biometric authentication device provides to the secure device 14 is not registered or is unauthorized. On the other hand, when the mutual authentication succeeds, the general service state control unit 404 establishes a session with the secure device 14 via the communication unit 402 for secure device. Furthermore, since the template encryption key corresponding to the service becomes usable at the secure device 14, the general service state control unit 404 acquires the template encryption key from the secure device 14.

Then, the general service state control unit 404 inputs an authentication complete notification indicating the establishment of mutual authentication to the encrypted template acquisition unit 410, and also inputs the template encryption key acquired from the secure device 14 to the template decryption unit 412. When the authentication complete notification is input, the encrypted template acquisition unit 410 acquires the encrypted template from the template management system 26 via the communication unit 408 for network. Then, the encrypted template acquired by the encrypted template acquisition unit 410 is input to the template decryption unit 412. When the template encryption key and the encrypted template are input, the template decryption unit 412 uses the input template encryption key, and decrypts the original template from the input encrypted template.

The template that has been decrypted by the template decryption unit 412 is input to the template checking unit 414. On the other hand, biometric pattern information is acquired at the biometric pattern acquisition unit 416 from a specific body part of the user. The biometric pattern information acquired by the biometric pattern acquisition unit 416 is input to the template checking unit 414. When the template and the biometric pattern information are input in this manner, the template checking unit 414 checks the template and the biometric pattern information that are input against each other, and decides whether or not they match each other to a certain level or more.

In the case the degree of their match is above the certain level, the template checking unit 414 decides that the biometric authentication succeeded, and inputs a biometric authentication result indicating the success of the biometric authentication to the service providing unit 418. When the biometric authentication result is input, the service providing unit 418 starts providing a specific service. On the other hand, in the case the degree of their match falls below the certain level, the template checking unit 414 outputs an error, having decided that the biometric authentication failed. As described, unlike the PC 12 described above, the biometric authentication device is a device that provides only the biometric authentication service. However, the biometric authentication service providing function is the same as that of the PC 12.

### 5-3: Functional Configuration of Template Management System (Biometric Authentication Function Part)

Here, the functional configuration of the template management system 26 will be described with reference to FIG. 22. FIG. 22 is an explanatory diagram showing the main functional configuration of the template management system 26. The template management system 26 is means for managing an encrypted template. For this purpose, the template management system 26 mainly includes a communication unit 502, a template encryption unit 504, and an encrypted template storage unit 506 as shown in FIG. 22.

The communication unit 502 is means for communicating via the network 30. In the biometric authentication system 10, the communication unit 502 is mainly used for providing the encrypted template to each of the biometric authentication devices. The template encryption unit 504 is means for encrypting a template that has been registered by using the template registration terminal 28. The template encryption key that is used at the template encryption unit 504 is provided by the service data management system 24 (refer to FIG. 2). At this time, the template encryption key for each service is provided to the template encryption unit 504.

When a template is input from the template registration terminal 28, the template encryption unit 504 encrypts the input template with the template encryption key for each service, and creates an encrypted template corresponding to each service, for example. Of course, it is also possible to encrypt a registered template for each service, but as the number of services increase, so does the burden on the user for registering the templates. Thus, it is more efficient to create an encrypted template for each service by using the template that was input once as described above. The encrypted template created by the template encryption unit 504 in this manner is stored in the encrypted template storage unit 506.

Additionally, the encrypted template storage unit 506 does not have to be tamper resistant. As described, in the biometric authentication system 10, it is not possible to use the template encryption key unless individual service is activated. Thus, even if a package service data or the encrypted template is exposed to a malicious third party, the original template is not decrypted from the encrypted template. Accordingly, unlike a general biometric authentication device as shown in FIG. 1, with the biometric authentication system 10 according to the present embodiment, the encrypted template does not have to be stored in a tamper resistant memory.

Now, the encrypted template stored in the encrypted template storage unit 506 is provided to a biometric authentication device via the communication unit 502 at the time of provision of a biometric authentication service. As has been described, encrypted templates that have been encrypted by using the template encryption key for each service are held in the template management system 26. Also, at the time of provision of a biometric authentication service, the template management system 26 provides the encrypted template that is held therein to a biometric authentication device. With such a configuration, a user is saved the trouble of going to the installation locations of biometric authentication devices provided for respective services to register the template.

### 5-4: Flow of Biometric Authentication Process

Here, a flow of a biometric authentication process of the biometric authentication system 10 will be described with reference to FIG. 23. FIG. 23 is an explanatory diagram showing a flow of a biometric authentication process of the biometric authentication system 10.

As shown in FIG. 23, when the provision of a biometric authentication service is started, the activation process of the service is attempted between a biometric authentication device and the secure device 14 (S182, S184). When the activation process of the service succeeds, they proceed to the process of step S186, and the decryption of an encrypted template is performed (S186). At this time, the biometric authentication device acquires the encrypted template from the template management system 26, and also acquires a template encryption key from the secure device 14, and then decrypts the original template from the encrypted template. When the template is decrypted and biometric pattern information is acquired from a body part of the user, the template and the biometric pattern information are checked against each other by the biometric authentication device (S188, S190).

In the case the biometric authentication succeeds, they proceed to the process of step S192, and a service inactivation process is performed by the biometric authentication device (S192), and the series of the biometric authentication process is ended. On the other hand, in the case the biometric authentication fails, an error is output by the biometric authentication device and the series of the biometric authentication process is ended. Additionally, when the service inactivation process is performed, the session between the biometric authentication device and the secure device 14 is cancelled, and also, the decryption of the encrypted template corresponding to the service is disabled. For example, the template encryption key stored in the volatile memory 216 of the secure device 14 is erased. Furthermore, the service is inactivated also in a case where the power to the secure device 14 is lost.

Heretofore, the flow of a series of processes relating to the provision of the biometric authentication service has been described.

### 6: Change/Deletion of Service

Next, the change process and the deletion process of a general service stored in the non-volatile memory 204 of the secure device 14 will be described.

### 6-1: Flow of Service Change Process

First, a general service change process will be described with reference to FIGS. 24 and 25. FIG. 24 is an explanatory diagram showing an outline of a process relating to change of a general service. Also, FIG. 25 is an explanatory diagram showing a flow of a processes relating to deletion of a general service.

A general service change process includes a step of acquiring new service data and a step of writing the new service data in the non-volatile memory 204. First, new service data (S_{sc}^{new}) is prepared by the service data management system 24. As with the service data registration process described above, the new service data is packaged by the service data management system 24, and is provided to the secure device 14 in the form of package service data (P_{sc}^{new}) At this time, a packaging function for service change (p₂; refer to FIG. 20) is used for the packaging of the new service data.

When the package service data is provided, the new service data S_{sc}^{new} is decrypted at the secure device 14 from the package service data. Then, a service ID included in the new service data that has been decrypted is extracted, and service data having the same service ID as the above is searched for within the non-volatile memory 204. When old service data having the same service ID is detected within the non-volatile memory 204, the secure device 14 compares the version information of the new service data and the version information of the old service data. When, as a result of comparison, it is confirmed that the version of the new service data is newer, the secure device 14 stores the new service data in the non-volatile memory 204.

The new service data is stored in the non-volatile memory 204 of the secure device 14 in this manner. However, as with the service data registration process, the service activation process is performed at the time of acquisition of the package service data. Also, after the new service data is stored in the non-volatile memory 204, the service is inactivated. Next, a flow of the service data change process including such service activation/inactivation processes will be described.

Reference will be made to FIG. 25. First, when the service change process is started, the service activation process is performed (S202, S204). Here, like the time of registration of a service, a service is activated by the method shown in FIG. 14. In the case the activation of the service fails, the PC 12 outputs an error and ends the service change process. In the case the activation of the service succeeds, they proceed to the process of step S206, and new package service data is acquired by the PC 12 and is provided to the secure device 14 (S206). Next, the new service data is decrypted from the newly acquired package service data by the secure device 14 (S208).

Then, the secure device 14 refers to the service ID of the new service data that has been decrypted, searches for service data that has the same service ID within the non-volatile memory 204, and checks the presence of old service data (S210, S212). In the case there is no old service data, update of service data is not performed. However, the service data may be newly registered, instead of being updated, and the series of processes may be organized so as to end with the writing of the acquired service data in the non-volatile memory 204. On the other hand, in the case there is old service data, the secure device 14 compares the version of the new service data (Ver_{new}) and the version of the old service data (Ver_{old}) (S214, S216).

In the case of Ver_{new}>Ver_{old}, the secure device 14 proceeds to the process of step S218, and writes the new service data into the non-volatile memory 204 (S218). On the other hand, in the case of Ver_{new}≦Ver_{old}, the secure device 14 does not write the new service data into the non-volatile memory 204, and ends the service data update process. When the process of step S218 is complete, the session between the PC 12 and the secure device 14 is cancelled, and the service is inactivated (S220). Then, the series of processes relating to the change of service is ended.

Heretofore, the change process of a general service has been described.

### (Change of System Service)

The substantially same process is performed for the change process of the system service. The largest difference between the general service and the system service is that the system service does not allow the presence of a plurality of versions. Thus, in the case of updating the system service, the old system service data is erased after the new system service data is written. If shutdown or the like occurs in a situation where the new system data has been written but the old system service data has not yet been erased, a situation may temporarily arise where a plurality of system services are present. Thus, in the case where a plurality of pieces of system service data are present within the non-volatile memory 204 at the time of the recovery of the system, a process of immediately erasing the old service data while keeping the system service data of the latest version is performed. Additionally, the packaging function (p₀; refer to FIG. 13) for system service change that is used at the time of changing the system service is used for the packaging function that is used at the time of packaging.

### 6-2: Flow of Service Deletion Process

Next, a service data deletion process will be described with reference to FIG. 26. FIG. 26 is an explanatory diagram showing a flow of processes relating to the deletion of service data.

As shown in FIG. 26, when a service data deletion process is started, a service which is a deletion target is activated (S222, S224). When the activation of the service fails, an error is output and the series of processes relating to the deletion of the service data is ended. On the other hand, when the activation of the service succeeds, the process proceeds to step S226, and the deletion target service data that is stored in the non-volatile memory 204 is deleted by the secure device 14 (S226). When the service data deletion process is over, the service that has been activated in step S222 is inactivated (S288), and the series of processes relating to the deletion of the service is ended.

Heretofore, a general service data deletion process has been described. Additionally, it is not allowed to delete the system service data.

### 7: Template Registration

Heretofore, a description has been made with the assumption that the encrypted template is registered in the template management system 26. Here, a template registration process will be briefly described.

### 7-1: Functional Configuration of Template Registration Terminal

First, the functional configuration of the template registration terminal 28 will be described with reference to FIG. 27. FIG. 27 is an explanatory diagram showing an example of the functional configuration of the template registration terminal 28.

As shown in FIG. 27, the template registration terminal 28 mainly includes a biometric pattern acquisition unit 602 and a communication unit 604. Furthermore, the biometric pattern acquisition unit 602 includes an imaging unit 612 and an image processing unit 614.

The biometric pattern acquisition unit 602 is means for acquiring a biometric pattern from a user's body part and for creating a template. Also, the imaging unit 612 is means for capturing the image of a specific body part and for acquiring image data of a biometric pattern. For example, the imaging unit 612 irradiates a near-infrared light on a specific body part, and receives a reflection of the irradiated light that has been reflected within the body. Furthermore, the imaging unit 612 photoelectrically converts the reflection received by an image sensor provided within, and generates an analog signal of the captured image. Then, the imaging unit 612 converts the analog signal into a digital signal, and outputs the image data of the biometric pattern. As described by this example, by using a near-infrared light, a vein pattern within a body can be detected, and the image data of the vein pattern can be obtained by the imaging unit 612.

The image data of the biometric pattern that is output from the imaging unit 612 is input to the image processing unit 614. A specific image process is performed on the image data at the image processing unit 614. For example, in the case image data having colour tones or gradation is input, a binarization process is performed on the image data. Furthermore, a process such as a spatial transformation is performed on the binarized image data obtained by the binarization process so that the image data is in a form that allows easy comparison with a template. For example, in the case a vein pattern is used as the biometric pattern, the binarized image data is converted into template data that is projected into a Hough space. For example, since the vein pattern is anisotropic, the matching accuracy of the pattern can be improved by using the data projected into the Hough space.

As described, an appropriate conversion process is performed according to the type of the biometric pattern that is used, and the image data is output as the template data. The template data that is output from the image processing unit 614 is input to the template management system 26 via the communication unit 604. The template data that is input to the template management system 26 is stored, being encrypted for each service as described above. Accordingly, once the registration with the template management system 26 is performed, the user can receive a desired biometric authentication without having to go to the installation location of each biometric authentication device and having to register the template.

### 7-2: Flow of Template Registration Process

According to the above-described template registration method, the encrypted template for each service was created at the server (the service data management system 24, the template management system 26). The advantage of this configuration is that a user does not have to be conscious of the services. That is, since the encrypted template for each service is automatically created for the services managed by the service data management system 24, the user does not, at this time point, have to think about the services that will be used in the future.

However, as shown in FIG. 28, a configuration is also possible according to which the encrypted template can be registered only for the service that is already registered in the secure device 14. Thus, a template registration method for a case where the encrypted template is allowed to be registered only for the service already registered in the secure device 14 will be described with reference to FIG. 28. However, to perform this method, a terminal with which the service activation/inactivation process can be performed becomes necessary. For example, the template registration terminal 28 provided with a part of the functions of the PC 12 that is provided to perform the service activation/inactivation process is used.

As shown in FIG. 28, when starting a template registration process, a user first activates a service corresponding to the template that is to be registered (S232, S234). The activation of the service is performed by the method shown in FIG. 14. In the case the activation of the service fails, an error is output and the template registration process is ended. On the other hand, in the case the activation of the service succeeds, the process proceeds to step S236, and a template (T) is created (S236). Next, the template created in step S236 is encrypted by the template encryption key information included in the service data, and an encrypted template (T_{enc}) is created (S238). Next, after the encrypted template T_{enc} is output (S240), the service is inactivated (S242), and the series of processes relating to the registration of the template is ended. The encrypted template can be registered in this manner. Additionally, in the biometric authentication system 50 illustrated in FIG. 3, the function of the template registration terminal is provided in the PC 52, and thus the template registration method shown in FIG. 28 is suitable.

### 8: Exchange of Template Encryption Key

Next, an exchange process of a template encryption key will be described with reference to FIG. 29. In the case the service update process is performed, the template encryption key corresponding to the service may sometimes also be updated. In such case, a template that was decrypted with the template encrypted key of the old version can be decrypted if the service of the old version still exists, but if it does not exist any longer, the decryption is not possible. Thus, a relocking process (exchange process) of the template encryption key that is performed when the template encryption key is updated will be specifically described with reference to FIG. 29.

As shown in FIG. 29, first, both an old service sc_{old} and a new service sc_{new} are activated (S252, S254). In the case the activation of both services fails, an error is output and the series of processes relating to the exchange of the template encryption key is ended. On the other hand, in the case the activation of both services succeeds, the process proceeds to step S256. In step S256, a template (T) is decrypted based on the template encryption key information included in the old service data (S256). Then, the template T that has been decrypted is encrypted by using the template encryption key information included in the new service data (S258). Then, the template that has been encrypted with the new template encryption key information is output (S260). Then, the service is inactivated (S262), and the series relating to the exchange of the template encryption key is ended. With the encrypted template exchanged to a new encrypted template, it becomes possible to delete the old template encryption key information.

Furthermore, the above-described processes may be batch-processed at the template management system 26 (and the service data management system 24) holding a plurality of encrypted templates. Furthermore, at the time of performing biometric authentication using an encrypted template, the template that is encrypted with the template encryption key of an old service may be optionally re-encrypted and output at the time of the success of the biometric authentication.

Heretofore, the management method of the encrypted template and of the template encryption key according to the present embodiment have been described in detail. By using these methods, a template is managed outside a biometric authentication device, and a secure and highly convenient biometric authentication service is provided. Lastly, an example of the hardware configuration for realizing the function of each device included in the biometric authentication systems 10 and 50 and the function of the systems will be described.

### 9: Hardware Configuration

The function of each device included in the biometric authentication systems 10 and 50 described above and the function of the systems can be realized, for example, by using the hardware configuration of an information processing apparatus shown in FIG. 30. That is, the function is realized by controlling the hardware shown in FIG. 30 by using a computer program. The mode of this hardware is arbitrary, and may be a personal computer, a mobile information terminal such as a mobile phone, a PHS or a PDA, a game machine, or various types of information appliances. Moreover, the PHS is an abbreviation for Personal Handy-phone System. Also, the PDA is an abbreviation for Personal Digital Assistant.

As shown in FIG. 30, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls an entire operation or a part of the operation of each structural element based on various programs recorded on the ROM 904, the RAM 906, the storage unit 920, or a removal recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. As a matter of course, the removal recording medium 928 may be, for example, an IC card on which a non-contact IC chip is mounted or an electronic device. The IC is an abbreviation for Integrated Circuit.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or various communication modems. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-167041 filed in the Japan Patent Office on Jul. 15, 2009, the entire content of which is hereby incorporated by reference.

What is claimed is:

1. A key storage device comprising:
a receiving unit for receiving package data that includes a template encryption key for decrypting an encrypted template for biometric authentication and an authentication key that is used for mutual authentication performed with a terminal that uses the template encryption key, the mutual authentication being performed at a time of placing the template encryption key in a usable state and the package data being in a data format that allows restoration only by the key storage device in which the template encryption key is stored;
a key information storage unit for restoring the template encryption key and the authentication key from the package data received by the receiving unit, and for storing the template encryption key and the authentication key in a tamper resistant non-volatile memory;
a mutual authentication unit for performing, in case a request for use of the template encryption key is received from the terminal, mutual authentication with the terminal by using authentication information that is based on the authentication key stored in the non-volatile memory; and
a key state management unit for placing, in case the mutual authentication by the mutual authentication unit succeeds, the template encryption key stored in the non-volatile memory in a state usable by the terminal.

2. The key storage device according to claim 1,
wherein a system authentication key that is used for mutual authentication performed with the terminal at a time of the template encryption key and the authentication key being stored by the key information storage unit is stored in advance in the non-volatile memory,
wherein the key storage device further includes a system mutual authentication unit for performing mutual authentication with the terminal by using the system authentication key stored in advance in the non-volatile memory, and
wherein, in case the mutual authentication by the system mutual authentication unit succeeds, the key information storage unit restores the template encryption key and the authentication key from the package data and stores the template encryption key and the authentication key in the non-volatile memory.

3. The key storage device according to claim 2, further comprising:
a system degenerate key generation unit for generating a system degenerate key from the system authentication key by using a specific system degenerate key generation function,
wherein the system mutual authentication unit performs mutual authentication with the terminal by using the system degenerate key generated by the system degenerate key generation unit.

4. The key storage device according to claim 3, further comprising:
a degenerate key generation unit for generating a degenerate key from the authentication key by using a specific degenerate key generation function,
wherein the mutual authentication unit performs mutual authentication with the terminal by using the degenerate key generated by the degenerate key generation unit.

5. The key storage device according to claim 4,
wherein, in case a request for use of a plurality of template encryption keys is received from the terminal in a state where a plurality of services exist, where the template encryption key is set for each of the services, and where the template encryption keys and authentication keys corresponding to the plurality of services are stored in the non-volatile memory,
the degenerate key generation unit generates one degenerate key by using the authentication keys corresponding to the plurality of services in relation to which the request for use has been received,
the mutual authentication unit performs mutual authentication with the terminal by using the one degenerate key generated by the degenerate key generation unit, and
the key state management unit places, in case the mutual authentication by the mutual authentication unit succeeds, a plurality of template encryption keys that correspond to the plurality of services in relation to which the request for use has been received and that are stored in the non-volatile memory in a state usable by the terminal.

6. The key storage device according to claim 1, wherein, in case the mutual authentication by the mutual authentication unit succeeds, the key state management unit copies, in a volatile memory, the template encryption key stored in the non-volatile memory, and places the template encryption key in the volatile memory in a state usable by the terminal while a session with the terminal is established.

7. A biometric authentication device comprising:
a biometric information acquisition unit for capturing an image of a biometric pattern, and for acquiring biometric information for biometric authentication;
an encrypted template acquisition unit for acquiring an encrypted template for biometric authentication;
a mutual authentication unit for acquiring authentication information that is used at a time of performing mutual authentication with a key storage device that stores a template encryption key for decrypting the encrypted template for biometric authentication in a tamper resistant non-volatile memory and that manages the template encryption key, and for performing mutual authentication with,the key storage device by using the authentication information;
a template decryption unit for decrypting the encrypted template for biometric authentication by using the template encryption key, in case the mutual authentication by the mutual authentication unit succeeds and the template encryption key is placed in a usable state by the key storage device; and
a biometric authentication unit for performing a biometric authentication process by checking, against each other, the template for biometric authentication decrypted by the template decryption unit and the biometric information acquired by the biometric information acquisition unit.

8. The biometric authentication device according to claim 7, further comprising:
a system mutual authentication unit for acquiring system authentication information to be used for mutual authentication that is performed at a time of storing the template encryption key in the non-volatile memory of the key storage device, and for performing mutual authentication with the key storage device by using the system authentication information; and
a package data providing unit for acquiring package data that includes the template encryption key along with an authentication key used for mutual authentication performed at a time of the key storage device placing the template encryption key in a usable state and that is in a data format that allows restoration only by the key storage device, and for providing the package data to the key storage device, in case the mutual authentication by the system mutual authentication unit succeeds.

9. A biometric authentication system comprising:
a key storage device including
a receiving unit for receiving package data that includes a template encryption key for decrypting an encrypted template for biometric authentication and an authentication key that is used for mutual authentication performed with a biometric authentication device that uses the template encryption key, the mutual authentication being performed at a time of placing the template encryption key in a usable state and the package data being in a data format that allows restoration only by the key storage device in which the template encryption key is stored,
a key information storage unit for restoring the template encryption key and the authentication key from the package data received by the receiving unit, and for storing the template encryption key and the authentication key in a tamper resistant non-volatile memory,
a first mutual authentication unit for performing, in case a request for use of the template encryption key is received from the biometric authentication device, mutual authentication with the biometric authentication device by using authentication information that is based on the authentication key stored in the non-volatile memory, and
a key state management unit for placing, in case the mutual authentication by the first mutual authentication unit succeeds, the template encryption key stored in the non-volatile memory in a state usable by the biometric authentication device; and
the biometric authentication device including
a biometric information acquisition unit for capturing an image of a biometric pattern, and for acquiring biometric information for biometric authentication,
an encrypted template acquisition unit for acquiring the encrypted template for biometric authentication,
a second mutual authentication unit for acquiring authentication information that is used at a time of performing mutual authentication with the key storage device, and for performing mutual authentication with the key storage device by using the authentication information,
a template decryption unit for decrypting the encrypted template for biometric authentication by using the template encryption key, in case the mutual authentication by the second mutual authentication unit succeeds and the template encryption key is placed in a usable state by the key storage device, and
a biometric authentication unit for performing a biometric authentication process by checking, against each other, the template for biometric authentication decrypted by the template decryption unit and the biometric information acquired by the biometric information acquisition unit.

10. A key management method comprising the steps of:
receiving package data that includes a template encryption key for decrypting an encrypted template for biometric authentication and an authentication key that is used for mutual authentication performed with a terminal that uses the template encryption key, the mutual authentication being performed at a time of placing the template encryption key in a usable state and the package data being in a data format that allows restoration only by a key storage device in which the template encryption key is stored;
restoring the template encryption key and the authentication key from the package data received in the step of receiving, and storing the template encryption key and the authentication key in a tamper resistant non-volatile memory;
performing, in case a request for use of the template encryption key is received from the terminal, mutual authentication with the terminal by using authentication information that is based on the authentication key stored in the non-volatile memory; and
placing, in case the mutual authentication succeeds in the step of performing mutual authentication, the template encryption key stored in the non-volatile memory in a state usable by the terminal.

11. A biometric authentication method comprising the steps of:
capturing an image of a biometric pattern, and acquiring biometric information for biometric authentication;
acquiring an encrypted template for biometric authentication;
acquiring authentication information that is used at a time of performing mutual authentication with a key storage device that stores a template encryption key for decrypting the encrypted template for biometric authentication in a tamper resistant non-volatile memory and that manages the template encryption key, and performing mutual authentication with the key storage device by using the authentication information;
decrypting the encrypted template for biometric authentication by using the template encryption key, in case the mutual authentication succeeds in the step of performing mutual authentication and the template encryption key is placed in a usable state by the key storage device; and
performing a biometric authentication process by checking, against each other, the template for biometric authentication decrypted in the step of decrypting and the biometric information acquired in the step of acquiring biometric information.

12. A biometric authentication method comprising the steps of:
receiving, by a key storage device provided with a tamper resistant non-volatile memory in which a template encryption key is stored, package data that includes a template encryption key for decrypting an encrypted template for biometric authentication and an authentication key that is used for mutual authentication performed with a biometric authentication device that uses the template encryption key, the mutual authentication being performed at a time of placing the template encryption key in a usable state and the package data being in a data format that allows restoration only by the key storage device;
restoring, by the key storage device, the template encryption key and the authentication key from the package data received in the step of receiving, and storing, by the key storage device, the template encryption key and the authentication key in a tamper resistant non-volatile memory;
performing, by the key storage device, mutual authentication with the biometric authentication device by using authentication information that is based on the authentication key stored in the non-volatile memory, in case a request for use of the template encryption key is received from the biometric authentication device;
placing, by the key storage device, the template encryption key stored in the non-volatile memory in a state usable by the biometric authentication device, in case the mutual authentication succeeds in the step of performing mutual authentication with the biometric authentication device;
capturing, by the biometric authentication device, an image of a biometric pattern, and acquiring, by the biometric authentication device, biometric information for biometric authentication;
acquiring, by the biometric authentication device, the encrypted template for biometric authentication;
acquiring, by the biometric authentication device, authentication information that is used at a time of performing mutual authentication with the key storage device, and performing, by the biometric authentication device, mutual authentication with the key storage device by using the authentication information;
decrypting, by the biometric authentication device, the encrypted template for biometric authentication by using the template encryption key, in case the mutual authentication succeeds in the step of performing mutual authentication with the key storage device and the template encryption key is placed in a usable state by the key storage device; and
performing, by the biometric authentication device, a biometric authentication process by checking, against each other, the template for biometric authentication decrypted in the step of decrypting and the biometric information acquired in the step of acquiring biometric information.

13. A program for causing a computer to realise:
a receiving function of receiving package data that includes a template encryption key for decrypting an encrypted template for biometric authentication and an authentication key that is used for mutual authentication performed with a terminal that uses the template encryption key, the mutual authentication being performed at a time of placing the template encryption key in a usable state and the package data being in a data format that allows restoration only by a key storage device in which the template encryption key is stored;
a key information storage function of restoring the template encryption key and the authentication key from the package data received by the receiving function, and of storing the template encryption key and the authentication key in a tamper resistant non-volatile memory;
a mutual authentication function of performing, in case a request for use of the template encryption key is received from the terminal, mutual authentication with the terminal by using authentication information that is based on the authentication key stored in the non-volatile memory; and
a key state management function of placing, in case the mutual authentication by the mutual authentication function succeeds, the template encryption key stored in the non-volatile memory in a state usable by the terminal.

14. A program for causing a computer to realise:
a biometric information acquisition function of capturing an image of a biometric pattern, and of acquiring biometric information for biometric authentication;
an encrypted template acquisition function of acquiring an encrypted template for biometric authentication;
a mutual authentication function of acquiring authentication information that is used at a time of performing mutual authentication with a key storage device that stores a template encryption key for decrypting the encrypted template for biometric authentication in a tamper resistant non-volatile memory and that manages the template encryption key, and of performing mutual authentication with the key storage device by using the authentication information;
a template decryption function of decrypting the encrypted template for biometric authentication by using the template encryption key, in case the mutual authentication by the mutual authentication function succeeds and the template encryption key is placed in a usable state by the key storage device; and
a biometric authentication function of performing a biometric authentication process by checking, against each other, the template for biometric authentication decrypted by the template decryption function and the biometric information acquired by the biometric information acquisition function.
